(19) United States
(12) Patent Application Publication
(10) Pub. No.: US 2024/0299854 A1
(43) Pub. Date: Sep. 12, 2024

(54) PROGRAM, INFORMATION PROCESSING DEVICE, AND INFORMATION PROCESSING METHOD

(71) Applicant: CYGAMES, INC., Tokyo (JP)

(72) Inventors: Koji Yamakoshi, Tokyo (JP); Koji Otani, Tokyo (JP); Yasuhiro Yamada, Tokyo (JP); Makoto Noguchi, Tokyo (JP); Yujiro Onishi, Tokyo (JP)

(73) Assignee: CYGAMES, INC., Tokyo (JP)

(21) Appl. No.: 18/665,217

(22) Filed: May 15, 2024

Related U.S. Application Data
(63) Continuation of application No. PCT/JP2022/042415, filed on Nov. 15, 2022.

(30) Foreign Application Priority Data
Nov. 18, 2021 (JP) 2021-188095

(51) Int. Cl. A63F 13/85

(52) U.S. Cl. CPC A63F 13/85

(57) ABSTRACT

The present embodiment provides a program that makes it easy for a player to manage game media. The arrangement is such that batch experience-value conversion is performed on the basis of an input by a player, in which the whole duplicate number for each subject character is converted into a pool experience value, where the subject characters are, among characters possessed by the player, all the characters whose duplicate numbers are greater than or equal to one and whose maximum levels have reached an upper-limit value of one hundred.

### CROSS-REFERENCE TO RELATED APPLICATIONS

This application is a continuation of International Patent Application No. PCT/JP2022/042415, having an international filing date of Nov. 15, 2022, which designated the United States, the entirety of which is incorporated herein by reference. Japanese Patent Application No. 2021-188095 filed on Nov. 18, 2021 is also incorporated herein by reference in its entirety.

### BACKGROUND OF THE INVENTION

The present invention relates to programs, information processing devices, and information processing methods.

There has hitherto been a known type of game device in which, as a method of providing a player with game media that are used in a game, such as characters and items, on the basis of a player input at a terminal device, a game medium to be provided to the player is determined from among a plurality of game media through a lottery at a server device, and the determined game medium is provided to the player.

Furthermore, with some game devices of this type, in the case where a game medium that is provided to the player is the same as a game medium already possessed by the player, an alternative game medium is provided to the player (see 1. JP-A-2013-156743).

With such game devices, however, there is a problem in that as the number of times that a game medium is provided increases, the number and kinds of game media possessed by the player increase, which results in increased work for the player in managing the game media.

### SUMMARY OF THE INVENTION

The present invention has been made in view of the situation described above, and it is an object thereof to provide a program, an information processing device, and an information processing method that makes it easy for a player to manage game media.

According to a first aspect of the disclosure, there is provided a program that causes a computer to function as:
a number-of-game-media update unit that, when a game medium has been granted to a player, increases the number of game media of the granted kind among game media of the player;
a first update unit that, on the basis of a first input by a player, decreases the number of game media of a selected kind among game media of the player and changes a first parameter of the game media within a prescribed value as a limit; and
a second update unit that, on the basis of a second input by a player, decreases the number of game media of a selected kind among game media of the player and changes a second parameter of the player,
wherein the second update unit, on the basis of a third input by a player, decreases the number of specific game media with which the first parameter has reached the prescribed value among game media of the player and changes the second parameter of the player.

According to a second aspect of the disclosure, there is provided an information processing device comprising:
a number-of-game-media update unit that, when a game medium has been granted to a player, increases the number of game media of the granted kind among game media of the player;
a first update unit that, on the basis of a first input by a player, decreases the number of game media of a selected kind among game media of the player and changes a first parameter of the game media within a prescribed value as a limit; and
a second update unit that, on the basis of a second input by a player, decreases the number of game media of a selected kind among game media of the player and changes a second parameter of the player,
wherein the second update unit, on the basis of a third input by a player, decreases the number of specific game media with which the first parameter has reached the prescribed value among game media of the player and changes the second parameter of the player.

According to a third aspect of the disclosure, there is provided an information processing method that is executed by one or more computers, wherein:
when a game medium has been granted to a player, the number of game media of the granted kind among game media of the player is increased;
on the basis of a first input by a player, the number of game media of a selected kind among game media of the player is decreased, and a first parameter of the game media is changed within a prescribed value as a limit;
on the basis of a second input by a player, the number of game media of a selected kind among game media of the player is decreased, and a second parameter of the player is changed; and
on the basis of a third input by a player, the number of specific game media with which the first parameter has reached the prescribed value among game media of the player is decreased, and the second parameter of the player is changed.

### BRIEF DESCRIPTION OF DRAWINGS

FIG. 1 is a schematic block diagram showing the configuration of an information processing system in an embodiment of the present invention.

FIG. 2 is a functional block diagram showing the functions of a server device in the embodiment of the present invention.

FIG. 3 is a functional block diagram showing the functions of a terminal device in the embodiment of the present invention.

FIG. 4 is a figure for explaining parameters in the embodiment of the present invention.

FIG. 5 is an illustration showing an image that is displayed in a display area of the terminal device in the embodiment of the present invention.

FIG. 6 is an illustration showing an image that is displayed in the display area of the terminal device in the embodiment of the present invention.

FIG. 7 is an illustration showing an image that is displayed in the display area of the terminal device in the embodiment of the present invention.

FIG. 8 is an illustration showing an image that is displayed in the display area of the terminal device in the embodiment of the present invention.

FIG. 9 is an illustration showing an image that is displayed in the display area of the terminal device in the embodiment of the present invention.

FIG. 10 is an illustration showing an image that is displayed in the display area of the terminal device in the embodiment of the present invention.

FIG. 11 is an illustration showing an image that is displayed in the display area of the terminal device in the embodiment of the present invention.

FIG. 12 is an illustration showing an image that is displayed in the display area of the terminal device in the embodiment of the present invention.

FIG. 13 is an illustration showing an image that is displayed in a display area of the terminal device in the embodiment of the present invention.

FIG. 14 is a flowchart showing a process at the terminal device in the embodiment of the present invention.

FIG. 15 is a flowchart showing a process at the terminal device in the embodiment of the present invention.

FIG. 16 is a flowchart showing a process at the terminal device in the embodiment of the present invention.

FIG. 17 is a flowchart showing a process at the terminal device in the embodiment of the present invention.

FIG. 18 is a flowchart showing a process at the terminal device in the embodiment of the present invention.

FIG. 19 is an illustration showing an image that is displayed in a display area of a terminal device in a modification of the present invention.

FIG. 20 is an illustration showing an image that is displayed in a display area of a terminal device in a modification of the present invention.

FIG. 21 is an illustration showing an image that is displayed in a display area of a terminal device in a modification of the present invention.

FIG. 22 is an illustration showing an image that is displayed in a display area of a terminal device in a modification of the present invention.

FIG. 23 is a flowchart showing a process at the terminal device in the embodiment of the present invention.

FIG. 24 is a flowchart showing a process at the terminal device in the embodiment of the present invention.

FIG. 25 is a flowchart showing a process at the terminal device in the embodiment of the present invention.

FIG. 26 is an illustration showing an image that is displayed in a display area of a terminal device in a modification of the present invention.

FIG. 27 is an illustration showing an image that is displayed in a display area of a terminal device in a modification of the present invention.

### DETAILED DESCRIPTION OF THE INVENTION

(1) The present embodiment pertains to a program that causes a computer to function as: a number-of-game-media update unit that, when a game medium has been granted to a player, increases the number of game media of the granted kind among game media of the player; a first update unit that, on the basis of a first input by a player, decreases the number of game media of a selected kind among game media of the player and changes a first parameter of the game media within a prescribed value as a limit; and a second update unit that, on the basis of a second input by a player, decreases the number of game media of a selected kind among game media of the player and changes a second parameter of the player, wherein the second update unit, on the basis of a third input by a player, decreases the number of specific game media with which the first parameter has reached the prescribed value among game media of the player and changes the second parameter of the player.

In the present embodiment, on the basis of a third input by a player, the number of specific game media with which a first parameter has reached a prescribed value among game media of the player is decreased, and a second parameter of the player is changed. Accordingly, it is possible to avoid an increase in the burden of managing game media even when the number of game media is increased.

(2) Furthermore, in the present embodiment, the second update unit may be configured to accept a third input by a player for each of the plurality of specific game media, to decrease the number of the specific game media for which the third input by the player has been accepted, and to change the second parameter of the player.

With this configuration, it is possible to decrease the number of specific game media for each kind of specific game medium and to change the second parameter in the case where a plurality of kinds of specific game media are provided.

(3) Furthermore, in the present embodiment, the second update unit may be configured to decrease the number of the specific game media and to change the second parameter and a third parameter of the player.

With this configuration, since the third parameter also changes when the number of the specific game media is decreased and the second parameter of the player is changed, it is possible to enhance player's motivation for decreasing the number of specific game media and changing the second parameter of the player.

(4) Furthermore, in the present embodiment, the second update unit may be configured to reset a duplicate number of the specific game media to an initial value thereof and to change the second parameter of the player.

With this configuration, it is possible to avoid an increase in the burden of managing game media even when the duplicate number of game media is increased.

(5) Furthermore, the present embodiment pertains to an information processing device including: a number-of-game-media update unit that, when a game medium has been granted to a player, increases the number of game media of the granted kind among game media of the player; a first update unit that, on the basis of a first input by a player, decreases the number of game media of a selected kind among game media of the player and changes a first parameter of the game media within a prescribed value as a limit; and a second update unit that, on the basis of a second input by a player, decreases the number of game media of a selected kind among game media of the player and changes a second parameter of the player, wherein the second update unit, on the basis of a third input by a player, decreases the number of specific game media with which the first parameter has reached the prescribed value among game media of the player and changes the second parameter of the player.

(6) Furthermore, the present embodiment pertains to an information processing method that is executed by one or more computers, wherein: when a game medium has been granted to a player, the number of game media of the granted kind among game media of the player is increased; on the basis of a first input by a player, the number of game media of a selected kind among game media of the player is decreased, and a first parameter of the game media is changed within a prescribed value as a limit; on the basis of a second input by a player, the number of game media of a selected kind among game media of the player is decreased, and a second parameter of the player is changed; and on the basis of a third input by a player, the number of specific game media with which the first parameter has reached the prescribed value among game media of the player is decreased, and the second parameter of the player is changed.

(7) Furthermore, the present embodiment pertains to a non-transitory computer-readable information storage medium storing a program that causes a computer to function as: a number-of-game-media update unit that, when a game medium has been granted to a player, increases the number of game media of the granted kind among game media of the player; a first update unit that, on the basis of a first input by a player, decreases the number of game media of a selected kind among game media of the player and changes a first parameter of the game media within a prescribed value as a limit; and a second update unit that, on the basis of a second input by a player, decreases the number of game media of a selected kind among game media of the player and changes a second parameter of the player, wherein the second update unit, on the basis of a third input by a player, decreases the number of specific game media with which the first parameter has reached the prescribed value among game media of the player and changes the second parameter of the player.

The following describes an embodiment of the present embodiment. Note that this embodiment, which will be described below, does not unduly limit the content of the present embodiment as recited in the claims. Furthermore, it is not necessarily the case that all the elements described in the context of this embodiment are necessary elements constituting the present embodiment.

### 1. Configuration of Information Processing System

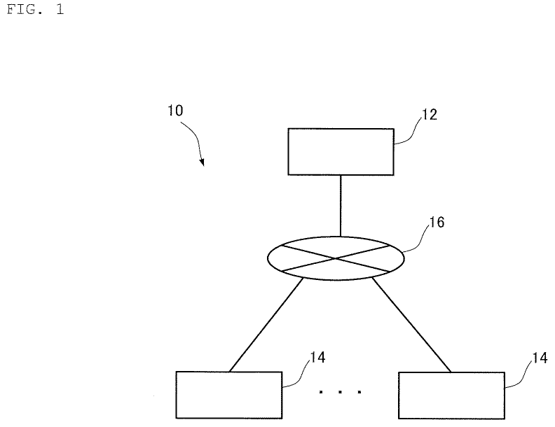

FIG. 1 is a schematic block diagram showing the configuration of an information processing system 10 in this embodiment. As shown in FIG. 1, in the information processing system 10, a server device 12 and a plurality of terminal devices 14 are connected via a network 16, such as the Internet, a mobile phone network, a LAN, or a WAN, constituting what is called a client-server communication system. Furthermore, each of the plurality of terminal devices 14 transmits and receives various kinds of information by mutually carrying out communication with the server device 12 via the network 16, and transmits and receives various kinds of information by mutually carrying out communication with the other terminal devices 14 via the network 16 and the server device 12.

The server device 12 includes a processor such as a CPU, a main storage device such as a ROM and a RAM, an external storage device such as a hard disk, an input device such as a keyboard, a display device such as a liquid crystal display, a communication device, etc. Furthermore, in the server device 12, the CPU executes various kinds of processing according to programs stored in the main storage device or programs loaded from the external storage device into the main storage device, thereby receiving information from the terminal devices 14 or transmitting information to the terminal devices 14 by means of the communication device.

Each of the terminal devices 14 may be an information processing device of various forms, such as a smartphone, a tablet, a personal computer, a mobile game machine, or an installed game machine, and each of these also includes a processor such as a CPU, a main storage device such as a ROM and a RAM, an external storage device such as a flash memory and a hard disk, an input device such as a touch panel, a keyboard, or a microphone, a display device such as a liquid crystal display or an organic EL display, a sound output device such as a speaker, a communication device, etc. Furthermore, also at the terminal device 14, the CPU executes various kinds of processing according to programs stored in the main storage device or programs loaded from the external storage device into the main storage device, thereby receiving information from the server device 12 or transmitting information to the server device 12 or the other terminal devices 14 by means of the communication device.

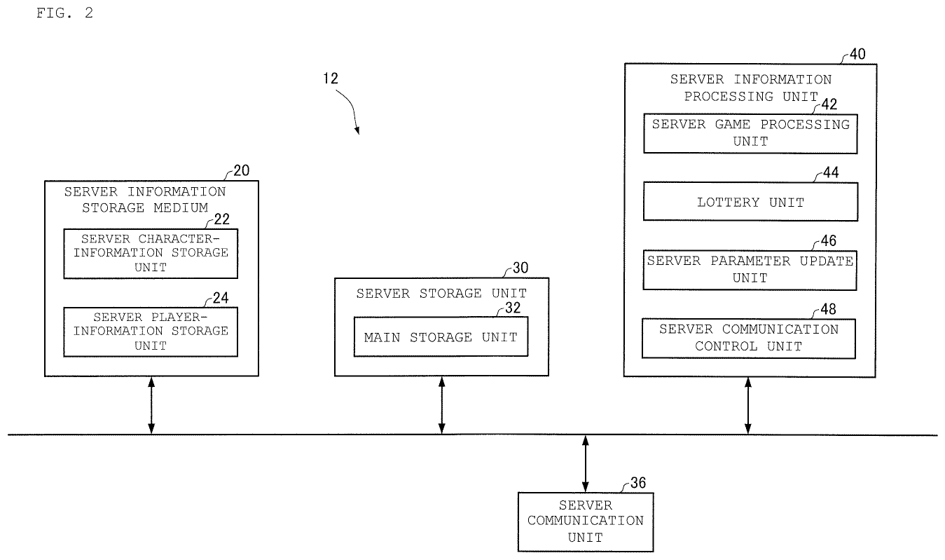

FIG. 2 is a functional block diagram showing the functions of the server device 12 in this embodiment. As shown in FIG. 2, the server device 12 in this embodiment includes a server information storage medium 20, a server storage unit 30, a server communication unit 36, and a server information processing unit 40. Note that some of the constituent elements (individual parts) in FIG. 2 may be omitted from the configuration.

The server information storage medium 20 stores programs, data, etc. for the server information processing unit 40 or the server communication unit 36 to perform various kinds of processing, and the function thereof can be realized by a flash memory, a hard disk, an optical disk (a DVD or a BD), or the like. That is, the server information storage medium 20 stores programs for causing a computer to function as the individual parts (programs for causing a computer to execute processing by the individual parts) in this embodiment.

The server storage unit 30 serves as a work area for the server information processing unit 40 or the server communication unit 36, and the function thereof can be realized by a RAM (a main memory), a VRAM (a video memory), or the like. Specifically, the server storage unit 30 includes a main storage unit 32 into which programs and data are loaded from the server information storage medium 20.

The server communication unit 36 performs various kinds of control for carrying out communication with an external network (e.g., other server devices or the terminal devices 14), and the function thereof can be realized by hardware such as a processor of various kinds (a CPU (a main processor), a GPU (a rendering processor), a DSP, or the like) or a communication ASIC, programs, or the like.

The server information processing unit 40, by using the main storage unit 32 as a work area, performs various kinds of processing such as game processing on the basis of received data received by the server communication unit 36, various kinds of programs and data in the server storage unit 30, etc., and the function thereof can be realized by hardware such as a processor of various kinds or an ASIC, or programs.

Furthermore, the server information processing unit 40 includes a server game processing unit 42, a lottery unit 44, a server parameter update unit 46, and a server communication control unit 48. Note that some of these may be omitted from the configuration.

The server game processing unit 42 performs processing including the following on the basis of received data received by the server communication unit 36, the results of various kinds of processing performed by the server information processing unit 40, programs and data loaded into the main storage unit 32, etc.: processing for starting a game in the case where a game start condition is satisfied; processing for executing a game mode selected from among a plurality of kinds of game modes; processing for proceeding with the game; processing for generating an event in the case where an event generation condition is satisfied; and processing for computing the result of the game or terminating the game in the case where a game termination condition is satisfied.

The lottery unit 44 performs lottery processing for determining, by means of a lottery, a game medium such as a character or an item to be granted to a player (player identification information or a player ID) from among a plurality of game media on the basis of received data received by the server communication unit 36, the results of various kinds of processing performed by the server information processing unit 40, programs and data loaded into the main storage unit 32, etc.

Specifically, in this embodiment, a plurality of kinds of lottery subject lists, specifying a plurality of kinds of game media as the subjects of lotteries, is stored in the server information storage medium 20. The lottery unit 44, upon receiving a request for executing lottery processing from one of the terminal devices 14, selects a lottery subject list corresponding to the request from the terminal device 14. Here, the lottery subjects in each kind of lottery subject list may be specified so as to be game media of all different kinds, may be specified so as to include game media of the same kind, or may be specified so as to include a lottery subject with which no game medium is to be granted.

Furthermore, the lottery unit 44 (a lottery processing unit), upon receiving a request for executing lottery processing from one of the terminal devices 14, obtains one random value from a random-value generation unit that randomly generates a random value for a lottery, and on the basis of the selected lottery subject list, determines the lottery-subject game medium corresponding to the one random value obtained as a game medium to be granted to the player.

Here, the random-number generation unit may be realized by a random-number generator that generates a hardware random number or a program that generates a software random number. A software random number can be generated, for example, on the basis of a count value of an increment counter (a counter that numerically counts cyclically within a prescribed count range). Note that in this embodiment, “random numbers” include not only values that are generated randomly in the mathematical sense but also values that are generated regularly in themselves but that can substantially function as random numbers because the acquisition timings or the like thereof are irregular.

Here, the lottery unit 44 is configured to be able to execute a plurality of kinds of lottery processing in which game media specified as lottery subjects are varied or the probabilities of winning of individual lottery subjects are varied. Furthermore, the configuration is such that each of the plurality of kinds of lottery processing may be performed on condition of the consumption of a for-charge in-game currency or a for-charge item, requiring payment in a real currency, or may be performed on condition of the consumption of a for-free in-game currency or a for-free ticket, not requiring payment in a real currency or an in-game currency.

The server parameter update unit 46 (a number-of-game-media update unit, a first update unit, and a second update unit) updates (changes) various kinds of parameters for each player or for each character, such as an experience value, a level, and an in-game currency, in the case where update conditions corresponding to the kinds of parameters are satisfied on the basis of received data received by the server communication unit 36, the results of various kinds of processing performed by the server information processing unit 40, programs and data loaded into the main storage unit 32, etc.

Specifically, in this embodiment, in the server information storage medium 20, a server character-information storage unit 22 (a game-medium storage unit) and a server player-information storage unit 24 are provided in association with each player. In the server character-information storage unit 22, various kinds of parameters are stored in association with each of all the characters that can be possessed by the player (player identification information or a player ID). In the server player-information storage unit 24, various kinds of parameters are stored in association with the player. Furthermore, in the case where the update conditions corresponding to the kinds of parameters are satisfied, the server parameter update unit 46 updates the parameters stored in the server character-information storage unit 22 or the server player-information storage unit 24.

The server communication control unit 48 performs processing for transmitting and receiving various kinds of information by causing the server communication unit 36 to carry out communication with other server devices 12 and the terminal devices 14. For example, the server communication control unit 48 causes the server communication unit 36 to transmit or receive information including the following: information required in processing for newly registering a player in the information processing system 10; information required in processing for allowing the player to log into the information processing system 10; information required in processing for setting another player who cooperates with or who plays a battle against the player who has logged in; information required in processing for synchronizing a plurality of terminal devices 14; and information required in processing for executing a common game at a plurality of terminal devices 14. Furthermore, the server communication control unit 48 also causes the server communication unit 36 to transmit or receive information including the following: destination information indicating the destination of information; source information indicating the source of information; and identification information identifying the information processing system 10 that has generated information.

In particular, the server communication control unit 48 performs the following kinds of processing: processing for transmitting, to one of the terminal devices 14, identification information of a character or identification information of an item that is to be granted to the player as a result of lottery processing by the lottery unit 44; transmitting, to one of the terminal devices 14, various kinds of parameters updated by the server parameter update unit 46; and receiving, from one of the terminal devices 14, information indicating the acceptance of a player input of various kinds at one of the terminal devices 14.

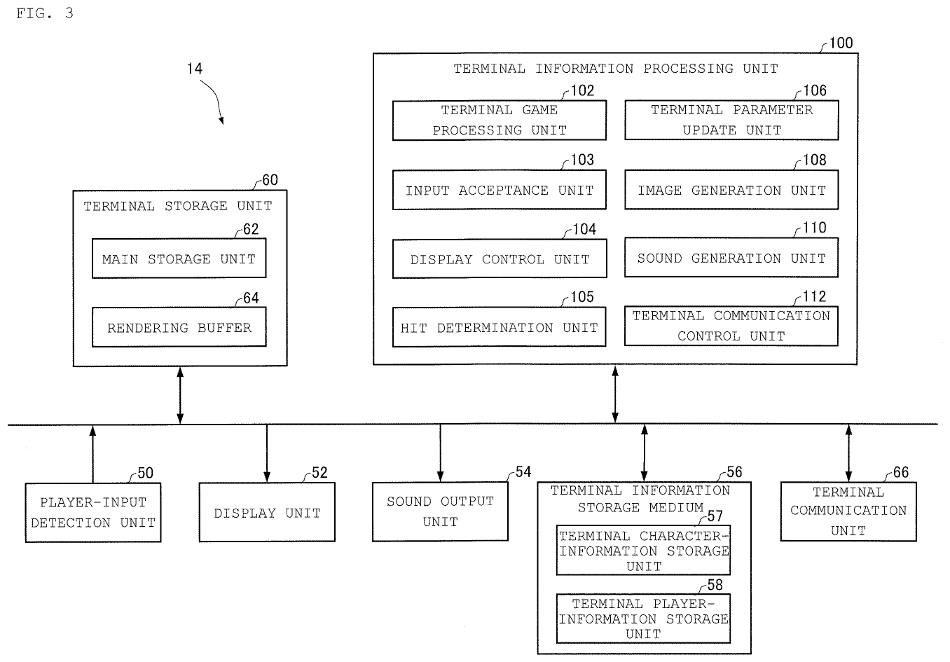

FIG. 3 is a functional block diagram showing the functions of each of the terminal devices 14 in this embodiment. As shown in FIG. 3, each of the terminal devices 14 in this embodiment includes a player-input detection unit 50, a display unit 52, a sound output unit 54, a terminal information storage medium 56, a terminal storage unit 60, a terminal communication unit 66, and a terminal information processing unit 100. Note that some of the constituent elements (individual parts) in FIG. 3 may be omitted from the configuration.

The player-input detection unit 50 serves to detect an input to the terminal device 14 by the player as a player input, and the function thereof can be realized by a touch sensor, a switch, an optical sensor, a microphone, or the like.

The display unit 52 displays an image on a display screen, and the function thereof can be realized by a liquid crystal display, an organic EL display, or the like.

The sound output unit 54 outputs sound, and the function thereof can be realized by a speaker, a headphone, or the like.

The terminal information storage medium 56 stores programs, data, etc. for the terminal information processing unit 100 or the terminal communication unit 66 to perform various kinds of processing, and the function thereof can be realized by a flash memory, a hard disk, an optical disk (a DVD or a BD), or the like. That is, the terminal information storage medium 56 stores programs for causing a computer to function as the individual parts (programs for causing a computer to execute processing by the individual parts) in this embodiment.

Specifically, in this embodiment, a terminal character-information storage unit 57 (a game-medium storage unit) and a terminal player-information storage unit 58 are provided in the terminal information storage medium 56. At prescribed timings, the content stored in the server character-information storage unit 22 and the content stored in the terminal character-information storage unit 57 are synchronized with each other, and the content stored in the server player-information storage unit 24 and the content stored in the terminal player-information storage unit 58 are synchronized with each other.

The terminal storage unit 60 serves as a work area for the terminal information processing unit 100 or the terminal communication unit 66, and the function thereof can be realized by a RAM (a main memory), a VRAM (a video memory), or the like. Specifically, the terminal storage unit 60 includes a main storage unit 62 into which programs and data are loaded from the terminal information storage medium 56, as well as a rendering buffer 64 in which an image to be displayed on the display unit 52 is rendered.

The terminal communication unit 66 performs various kinds of control for carrying out communication with an external network (e.g., the server device 12 or the other terminal devices 14), and the function thereof can be realized by hardware such as a processor of various kinds or a communication ASIC, programs, or the like.

Note that the programs (data) for causing a computer to function as the individual parts in this embodiment may be downloaded from the server device 12 to the terminal information storage medium 56 (or the main storage unit 62) of the terminal device 14 via the network 16 and the terminal communication unit 66. Such usage of the server device 12 may also be included in the scope of the present embodiment.

The terminal information processing unit 100, by using the main storage unit 62 as a work area, performs various kinds of processing such as game processing, image generation processing, and sound generation processing on the basis of player inputs detected by the player-input detection unit 50, received data received by the terminal communication unit 66, various kinds of programs and data in the terminal storage unit 60, etc., and the function thereof can be realized by hardware such as a processor of various kinds (a CPU (a main processor), a GPU (a rendering processor), a DSP, or the like) or an ASIC, or programs.

Furthermore, the terminal information processing unit 100 includes a terminal game processing unit 102, an input acceptance unit 103, a display control unit 104, a hit determination unit 105, a terminal parameter update unit 106, an image generation unit 108, a sound generation unit 110, and a terminal communication control unit 112. Note that some of these may be omitted from the configuration.

The terminal game processing unit 102 performs processing including the following on the basis of player inputs detected by the player-input detection unit 50, received data received by the terminal communication unit 66, the results of various kinds of processing performed by the terminal information processing unit 100, programs and data loaded into the main storage unit 62, etc.: processing for starting a game in the case where a game start condition is satisfied; processing for executing a game mode selected from among a plurality of kinds of game modes; processing for proceeding with the game; processing for generating an event in the case where an event generation condition is satisfied; and processing for computing the result of the game or terminating the game in the case where a game termination condition is satisfied.

The input acceptance unit 103 accepts an input by the player as an input depending on the situation or prohibits an input by the player from being accepted on the basis of player inputs detected by the player-input detection unit 50, received data received by the terminal communication unit 66, the results of various kinds of processing performed by the terminal information processing unit 100, programs and data loaded into the main storage unit 62, etc. For example, when a GUI such as a button is tapped in a state where the GUI is displayed, the tap is accepted as an input corresponding to the kind of GUI displayed.

Specifically, in addition to accepting player inputs for moving characters or causing character to perform actions, the input acceptance unit 103 accepts player inputs for executing lottery processing by the lottery unit 44 at the server device 12 and accepts player inputs for changing various kinds of parameters.

The display control unit 104 performs display control for images that are displayed on the display unit 52. Specifically, the display control unit 104 performs display control concerning the content of display, the mode of display, the timing of display, etc. of various kinds of objects and pre-rendering images (movie images) on the basis of player inputs detected by the player-input detection unit 50, received data received by the terminal communication unit 66, the results of various kinds of processing performed by the terminal information processing unit 100, programs and data loaded into the main storage unit 62, etc.

In this embodiment, the terminal information storage medium 56 has stored therein object data of various kinds of objects and image data of various kinds of pre-rendering images, the various kinds of objects including background objects for displaying backgrounds, effect objects for displaying effects, GUI objects for displaying graphic user interfaces (GUIs) such as buttons, character objects for displaying characters, and non-character objects for displaying things other than characters, such as buildings, tools, vehicles, and terrains. Furthermore, the display control unit 104 performs display control for objects and pre-rendering images, depending on the kind of game mode being executed, the status of progress of the game, etc., on the basis of object data and image data of pre-rendering images loaded into the main storage unit 62.

Specifically, the display control unit 104, on the basis of object data loaded into the main storage unit 62, performs processing for disposing objects in an object space or causing objects to move or perform actions, the objects being constituted of primitives representing the objects, such as polygons, freeform surfaces, or two-dimensional images. Specifically, on the basis of player inputs detected by the player-input detection unit 50, received data received by the terminal communication unit 66, the results of various kinds of processing performed by the terminal information processing unit 100, programs and data loaded into the main storage unit 62, etc., the display control unit 104, per one frame (e.g., 1/30seconds), determines the positions and orientations (rotation angles) of objects in the object space, and disposes the objects at the determined positions and in the determined orientations or causes a plurality of parts constituting the objects to individually perform actions.

Furthermore, in the case where a three-dimensional game image is to be displayed, the display control unit 104 performs processing for controlling the position, rotation angle (a line-of-sight direction), and angle of view of a virtual camera (a viewpoint) for generating an image as viewed from a given (arbitrary) viewpoint in the object space. In this embodiment, the display control unit 104 controls the position and orientation of the virtual camera so that the virtual camera will follow changes in the position and orientation of a character object that moves and performs actions on the basis of player inputs.

The hit determination unit 105 determines whether or not an attack by a certain character object has hit another character object (collision determination). Specifically, each attacking action by a character object has an attacking range set thereto, and when a character object performs an attacking action, an attacking direction is determined on the basis of the orientation of the character object at that timing, and an attacking range is set in the determined attacking direction. The hit determination unit 105 determines whether or not the set attacking range overlaps the range of the character object being attacked, and determines that the character object has been hit in the case where the attacking range overlaps the range of the character object. In this embodiment, a plurality of kinds of attacking actions are provided as attacking actions by a character object, including those with which the attacking range is set in the proximity of the character object, like punching, kicking, or slashing with a sword, as well as those with which the attacking range is moved to a position remote from the character object, like shooting with a gun, blowing fire, or using a magic.

The terminal parameter update unit 106 updates various kinds of parameters of the player, such as an experience value, a level, and an in-game currency, in the case where update conditions corresponding to the kinds of parameters are satisfied. In particular, each of a plurality of kinds of characters has set thereto hit points (life or stamina) as a parameter with which the character's activity becomes disabled when the parameter becomes zero. When it is determined that an attack has hit a character, the terminal parameter update unit 106 decreases the hit points of the attacked character in accordance with the parameters of the attacking character, such as the attacking ability. Furthermore, when an item or magic for recovering the hit points has been used, the terminal parameter update unit 106 increases the hit points of the character for which the item or magic has been used.

The image generation unit 108, on the basis of player inputs detected by the player-input detection unit 50, received data received by the terminal communication unit 66, the results of various kinds of processing performed by the terminal information processing unit 100, in particular, the results of various kinds of processing performed by the display control unit 104, program and data loaded into the main storage unit 62, etc., performs processing for rendering a game image in the rendering buffer 64 on a per-frame basis, thereby generating a game image in which various kinds of objects and various kinds of pre-rendering images are displayed, and outputs the generated game image to the display unit 52, on which the game image is displayed.

The sound generation unit 110 performs sound processing on the basis of the results of various kinds of processing performed by the terminal information processing unit 100, thereby generating game sound such as BGM, sound effects, or voice, and outputs the resulting sound to the sound output unit 54.

The terminal communication control unit 112 (a lottery-information reception unit and an input-information transmission unit) performs processing for transmitting and receiving various kinds of information by causing the terminal communication unit 66 to carry out communication with the server device 12 or the other terminal devices 14. For example, the terminal communication control unit 112 causes the terminal communication unit 66 to transmit or receive information including the following: information required in processing for newly registering the player in the information processing system 10; information required in processing for allowing the player to log into the information processing system 10; information required in processing for setting another player who cooperates with or who plays a battle against the player who has logged in; information required in processing for synchronizing a plurality of terminal devices 14; and information required in processing for executing a common game at a plurality of terminal devices 14. Furthermore, the terminal communication control unit 112 also causes the terminal communication unit 66 to transmit or receive information including the following: destination information indicating the destination of information; source information indicating the source of information; and identification information identifying the information processing system 10 that has generated information.

In particular, the terminal communication control unit 112 performs the following kinds of processing: processing for receiving, from the server device 12, identification information of a character or identification information of an item that is to be granted to the player as a result of lottery processing by the lottery unit 44; receiving, from the server device 12, various kinds of parameters updated by the server parameter update unit 46; and transmitting, to the server device 12, information indicating the acceptance of a player input of various kinds at the terminal device 14.

### 2. Control Method in This Embodiment

The following describes a control method in this embodiment in detail, in the context of an example in which a game program in this embodiment is applied as a game app for smartphones (the terminal devices 14).

The game program in this embodiment is configured so that a plurality of kinds of modes can be executed. The game program in this embodiment is configured so that, in a quest mode, which is the main game mode, a player can play an action RPG in which the player plays battles against enemy characters by causing a player character to move or to perform actions or by using items, while consuming items or parameters such as hit points, and clears quests while increasing parameters such as an experience value, a level, or an in-game currency or acquiring items depending on the results of the battles.

Specifically, in this embodiment, a player party is formed of one player character and three non-player characters selected from among characters possessed by the player. The configuration is such that, in the quest mode, when the player causes the player character to move or to perform an action, the movements and actions of the three non-player characters are automatically controlled, whereby the player party plays a battle against enemy characters.

Furthermore, the game program in this embodiment is configured so that, in addition to the quest mode, a plurality of kinds of auxiliary game modes can be executed, including the following: a character mode, in which a player party is formed or the members of the player party are changed and in which characters possessed by the player are strengthened; a shop mode, in which characters or items are purchased by consuming an in-game currency; and a lottery mode, in which game media determined through lotteries, such as characters and items, are granted to the player.

Here, in this embodiment, in addition to a protagonist character defined as the player character, the characters possessed by the player include characters that have become friends in the course of a story in the game and characters granted through lotteries. Since there are cases where a character granted through a lottery is the same as one of the characters possessed by the player, the number of characters that the player possesses duplicates increases as the number of times of lotteries increases.

Meanwhile, with some existing game programs, in the case where characters possessed by the player are displayed in a character mode or the like, with characters that the player possesses duplicates, the duplicates of those characters are displayed. As the number of times of lotteries increases, the number of characters with which duplicates thereof are displayed increases, which has been a management burden for the player.

Furthermore, with some existing game programs, in the case where a character that is the same as one of the characters possessed by the player is assigned, an alternative item is granted to the player. As the number of times of lotteries increases, the number of alternative items increases, which has been a management burden for the player.

Thus, in this embodiment, each time a character that is the same as one of the characters possessed by the player is granted, the duplicate number of that character is increased, and for a character selected by the player, the duplicate number of that character is displayed, and the duplicate number is decreased on the basis of a player input, while changing another parameter.

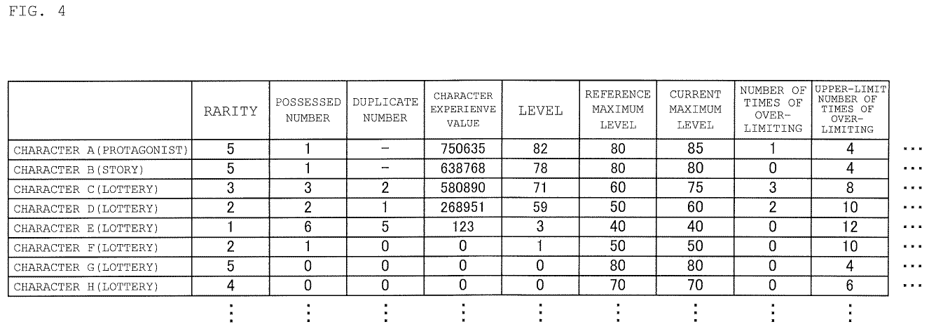

FIG. 4 is a figure showing various kinds of parameters stored in the server character-information storage unit 22 of the server device 12. As shown in FIG. 4, in the server character-information storage unit 22, a rarity, a possessed number (the number of game media), a duplicate number (the number of game media), a character experience value, a level, etc. are stored for each of all the characters that may be possessed by a player.

For example, for character A, which is the protagonist character, the rarity is set to “5”, which is the highest, and the possessed number is set to “1” from an initial state, which is the state in which the game is started for the first time. Furthermore, for character A, since character A is not granted further through a lottery, the possessed number is not increased from “1”, and the duplicate number is not increased either.

Furthermore, for character B, which is a character who has become a friend in the course of a story in the game, the rarity is set to “5”, which is the highest. The possessed number is set to “0” in the initial state, and when character B becomes a friend in the course of a story in the game, the possessed number is increased from “0” to “1”. Furthermore, also for character B, since character B is not granted further through a lottery, the possessed number is not increased from “1”, and the duplicate number is not increased either.

Meanwhile, for character C, which is a character that is granted through a lottery, the rarity is set to “3”, which is intermediate. The possessed number is set to “0” and the duplicate number is set to “0” in the initial state, and when character C has been granted through a lottery, the possessed number is increased from “0” to “1”. Furthermore, for character C, when character C has been further granted through a lottery, the possessed number is increased from “1” to “2”, and the duplicate number is increased from “0” to “1”. That is, for character C, each time character C is granted through a lottery, “1” is added to the possessed number, and a value obtained by subtracting 1 from the possessed number is set as the duplicate number. In the example in FIG. 4, since the possessed number of character C is “3”, the duplicate number thereof is “2”.

Furthermore, for character D, which is a character that is granted through a lottery, the rarity is set to “2”, which is the second lowest. The possessed number is set to “0” and the duplicate number is set to “0” in the initial state, and each time character D is granted through a lottery, “1” is added to the possessed number, and a value obtained by subtracting 1 from the possessed number is set as the duplicate number. In the example in FIG. 4, since the possessed number of character D is “2”, the duplicate number thereof is “1”.

Furthermore, for character E, which is a character that is granted through a lottery, the rarity is set to “1”, which is the lowest. The possessed number is set to “0” and the duplicate number is set to “0” in the initial state, and each time character E is granted through a lottery, “1” is added to the possessed number, and a value obtained by subtracting 1 from the possessed number is set as the duplicate number. In the example in FIG. 4, since the possessed number of character E is “6”, the duplicate number thereof is “5”.

Furthermore, for character F, which is a character that is granted through a lottery, the rarity is set to “2”, which is the second lowest. The possessed number is set to “0” and the duplicate number is set to “0” in the initial state, and each time character F is granted through a lottery, “1” is added to the possessed number, and a value obtained by subtracting 1 from the possessed number is set as the duplicate number. In the example in FIG. 4, since the possessed number of character F is “1”, the duplicate number thereof is “0”.

Furthermore, for character G, which is a character that is granted through a lottery, the rarity is set to “5”, which is the highest. The possessed number is set to “0” and the duplicate number is set to “0” in the initial state, and each time character G is granted through a lottery, “1” is added to the possessed number, and a value obtained by subtracting 1 from the possessed number is set as the duplicate number. In the example in FIG. 4, since the possessed number of character G is “0”, the duplicate number thereof is also “0”.

Furthermore, for character H, which is a character that is granted through a lottery, the rarity is set to “4”, which is the second highest. The possessed number is set to “0” and the duplicate number is set to “0” in the initial state, and each time character H is granted through a lottery, “1” is added to the possessed number, and a value obtained by subtracting 1 from the possessed number is set as the duplicate number. In the example in FIG. 4, since the possessed number of character H is “0”, the duplicate number thereof is also “0”.

That is, in the example in FIG. 4, character A to character F, for which the possessed numbers are greater than or equal to one, are characters possessed by the player; whereas character G and character H, for which the possessed numbers are zero, are characters not possessed by the player.

Furthermore, in this embodiment, each time a quest is cleared, a character experience value is increased for each character depending on the cleared quest. When the character experience value has reached a threshold defined for each level, the level of the character for which the character experience value has reached the threshold is raised, and depending on the raised level, parameters of the character, such as hit points and attacking ability, are also raised.

Furthermore, in this embodiment, when a quest has been cleared by a player party, the character experience values of the characters participating in the player party that has cleared the quest are increased, while the character experience values of the characters not participating in the player party that has cleared the quest are not changed. Thus, a difference in character experience value occurs between the characters participating in the player party and the characters not participating therein, whereby a difference in level occurs. In the example in FIG. 4, the character experience value of character A is “750635” and thus the level of character A is “82”, while the character experience value of character F is “0” and thus the level of character F is “1”.

Furthermore, in this embodiment, a reference maximum level, which is the maximum level (a first parameter) of each character in the initial state, is predefined depending on the rarity of that character. Specifically, as shown in FIG. 4, the reference maximum level is set to “80” for character A, etc. having the rarity “5”, the reference maximum level is set to “70” for character H, etc. having the rarity “4”, the reference maximum level is set to “60” for character C, etc. having the rarity “3”, the reference maximum level is set to “50” for character D, etc. having the rarity “2”, and the reference maximum level is set to “40” for character E, etc. having the rarity “1”.

Furthermore, in this embodiment, when the level of a character has reached the maximum level, the character experience value of that character no longer increases, which prohibits the level thereof from being raised. However, when the player performs over-limiting (upper-limit value processing) for raising (changing) the maximum level of the character by consuming a special item or the like, the maximum level is raised by “5” when over-limiting is performed once. Note that the special item is added to items possessed by the player when the item is purchased by consuming an in-game currency, when the item is granted through a lottery, or when the item is granted as a result of clearing a quest.

In the example in FIG. 4, although the reference maximum level of character A is “80”, since the current maximum level is “85” as a result of over-limiting having been performed once for character A, the level of character A is “82”. Furthermore, although the reference maximum level of character C is “60”, since the current maximum level is “75” as a result of over-limiting having been performed three times for character C, the level of character C is “71”.

Furthermore, in this embodiment, the upper-limit number of times of over-limiting for each character is predefined depending on the rarity of that character. Specifically, as shown in FIG. 4, the upper-limit number of times of over-limiting is set to “4” for character A, etc. having the rarity “5”, the upper-limit number of times of over-limiting is set to “6” for character H, etc. having the rarity “4”, the upper-limit number of times of over-limiting is set to “8” for character C, etc. having the rarity “3”, the upper-limit number of times of over-limiting is set to “10” for character D, etc. having the rarity “2”, and the upper-limit number of times of over-limiting is set to “12” for character E, etc. having the rarity “1”.

Therefore, in this embodiment, for a character of any rarity, it is possible to raise the level thereof to “100” (a prescribed value), which is the upper-limit value of the maximum level, by performing over-limiting the peer-limit number of times set for that character.

As described above, in this embodiment, in the server character-information storage unit 22, for each of all the characters that may be possessed by a player, various kinds of parameters are also stored, including hit points, an attacking ability, a reference maximum level, a current maximum level, the number of times of over-limiting, and an upper-limit number of over-limiting.

Furthermore, in this embodiment, although not shown, a pool experience value (a second parameter) is stored in the server player-information storage unit 24 of the server device 12, the pool experience value being increased in association with each player, not on a per-character basis. Furthermore, while being increased as the time elapses from the timing when the game was first started, each time a quest is cleared, the pool experience value is increased in accordance with the cleared quest.

Specifically, the pool experience value is increased by one per minute from the timing when the game was first started, regardless of whether or not the player is playing the game. Accordingly, when the player resumes the game, the pool experience value is increased compared with when the player quit the game last time, which enhances the player's motivation. Note, however, the pool experience value is not increased in the case where a prescribed period (e.g., one year) has passed since the last log-in.

Furthermore, as described earlier, when the level of a character has reached the maximum level, the character experience value of that character no longer increases, which prohibits the level thereof from being raised. However, a character experience value that is granted to a character that has reached the maximum level as a result of using the character that has reached the maximum level, i.e., for example, as a result of letting the character participate in a party and clearing a quest, is converted into a pool experience value, whereby the pool experience value is increased, while the character experience value of the character that has reached the maximum level is not increased. This makes it possible to acquire a pool experience value by letting a character that has reached the maximum level participate in a party.

Furthermore, in this embodiment, although not shown, the number of exchange items that can be exchanged for a character, an item, or the like (a third parameter) is stored in the server player-information storage unit 24 of the server device 12, the number of exchange items being increased in association with each player, not on a per-character basis. The number of exchange items is increased when one of various kinds of conditions is satisfied, for example, when an item is granted as a compensation in the case where a problem occurred in the game.

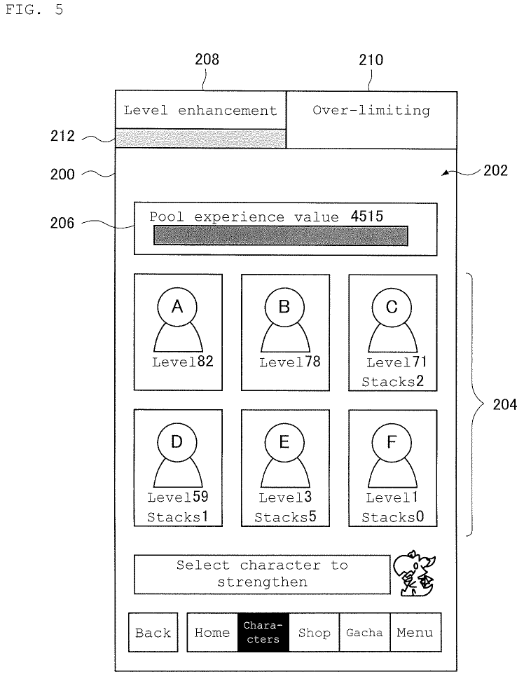

FIG. 5 is an illustration showing an example game image that is displayed in a display area 200 of a touch panel display of a smartphone by the game program in this embodiment. Among game images in the character mode, FIG. 5 shows an example character-to-strengthen selection image 202 for selecting a character that is to be strengthened among the characters possessed by the player.

As shown in FIG. 5, in the character-to-strengthen selection image 202, in a middle part of the display area 200, on the basis of the content stored in the terminal character-information storage unit 57, one character button 204 is displayed for each character possessed by the player, i.e., for each character with which the possessed number is greater than or equal to one, and in each character button 204, the level of the character is displayed under an image indicating the appearance of that character.

In the example in FIG. 5, “level 82” is displayed in the character button 204 corresponding to character A, “level 78” is displayed in the character button 204 corresponding to character B, “level 71” is displayed in the character button 204 corresponding to character C, “level 59” is displayed in the character button 204 corresponding to character D, “level 3” is displayed in the character button 204 corresponding to character E, and “level 1” is displayed in the character button 204 corresponding to character F.

Furthermore, in the character button 204 corresponding to each character granted through a lottery, the duplicate number (the number of stacks) of that character (a specific indication) is displayed under the level display.

In the example in FIG. 5, “2 stacks” is displayed in the character button 204 corresponding to character C, “1 stack” is displayed in the character button 204 corresponding to character D, “5 stacks” is displayed in the character button 204 corresponding to character E, and “0 stacks” is displayed in the character button 204 corresponding to character F. Meanwhile, as described earlier, no duplicate number is set for character A, which is the protagonist character, or for character B, which is a character that has become a friend in the course of a story in the game. Thus, no duplicate number is displayed in the character buttons 204 individually corresponding to character A and character B.

As described above, in this embodiment, in the character-to-strengthen selection image 202, for each character with which the possessed number is greater than or equal to one, one character button 204 corresponding to that character is displayed. In each character button 204, the level of the character is displayed, and the duplicate number of the character is displayed. Accordingly, in this embodiment, the player can recognize the duplicate number of each character in the character-to-strengthen selection image 202, while not displaying a plurality of character buttons 204 corresponding to the same character.

Furthermore, in the character-to-strengthen selection image 202, a pool-experience-value indication 206 indicating the pool experience value is displayed above the plurality of character buttons 204 on the basis of the content stored in the terminal player-information storage unit 58. In the example in FIG. 5, it is displayed that the pool experience value is “4515”.

Furthermore, in the character-to-strengthen selection image 202, a level-enhancement selection button 208 and an over-limiting selection button 210 are displayed in an upper part of the display area 200, the level-enhancement selection button 208 being a button for selecting, as character strengthening, level enhancement in which the level of a character is raised by using the pool experience value, and the over-limiting selection button 210 being a button for selecting, as character strengthening, over-limiting in which the maximum level of a character is raised by consuming a special item or the like.

Furthermore, in this embodiment, when the level-enhancement selection button 208 is tapped, as shown in FIG. 5, a selection indication 212 is displayed in a lower part of the level-enhancement selection button 208, indicating that the level-enhancement selection button 208 is currently selected. Meanwhile, when the over-limiting selection button 210 is tapped, although not shown, a selection indication 212 is displayed in a lower part of the over-limiting selection button 210. Note that in the initial state of the character strengthening image, as shown in FIG. 5, the selection indication 212 is displayed in a lower part of the level-enhancement selection button 208.

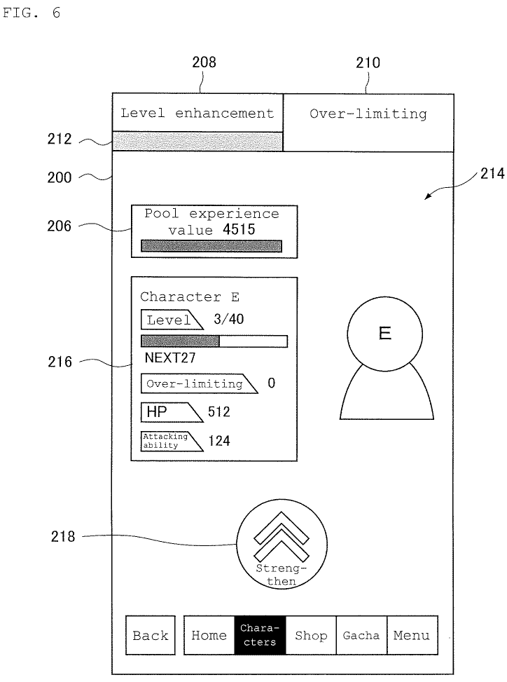

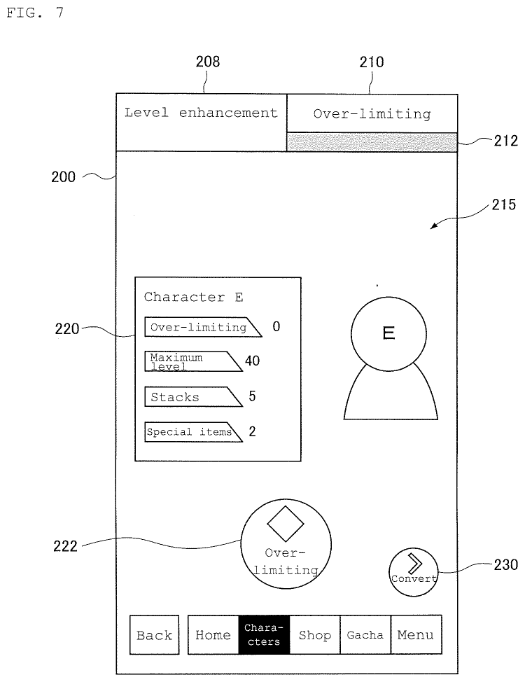

Furthermore, when one of the character buttons 204 has been tapped in the state where the selection indication 212 is displayed in the level-enhancement selection button 208, the character corresponding to the tapped character button 204 is selected. Then, as shown in FIG. 6, a level enhancement image 214 is displayed, via which a player input for enhancing the level of the selected character is accepted. Meanwhile, when one of the character buttons 204 is tapped in the state where the selection indication 212 is displayed in the over-limiting selection button 210, the character corresponding to the tapped character button 204 is selected. Then, as shown in FIG. 7, an over-limiting image 215 is displayed, via which a player input for performing over-limiting for the selected character is accepted.

As shown in FIG. 6, in the level enhancement image 214, an image indicating the appearance of the selected character is displayed in a middle right part of the display area 200, a pool-experience-value indication 206 indicating the pool experience value is displayed in an upper left part of the display area 200 on the basis of the content stored in the terminal player-information storage unit 58, and a first list indication 216 indicating various kinds of parameters of the selected character is displayed in a middle left part of the display area 200 on the basis of the content stored in the terminal character-information storage unit 57. In this embodiment, the following items of information are displayed in the first list indication 216: the current level and the current maximum level of the selected character; the character experience value necessary for advancing the level of the selected character to the next level; the number of times of over-limiting of the selected character; the hit points of the selected character; and the attacking ability of the selected character.

In the example in FIG. 6, in which the level enhancement image 214 for character E is displayed, the pool-experience-value indication 206 indicates that the pool experience value possessed by the player is “4515”, and the first list indication 216 indicates that the current level of character E is “3”, the current maximum level of character E is “40”, the character experience value necessary for advancing the level of character E to the next level is “27”, the number of times of over-limiting of character E is “0”, the hit points of character E is “512”, and the attacking ability of character E is “124”.

Furthermore, in the level enhancement image 214, an enhancement button 218 having a circular shape is displayed in a lower middle part of the display area 200. When the player holds the enhancement button 218 in the state where the pool experience value possessed by the player is greater than or equal to one (in the case where a fourth player input is performed), while the enhancement button 218 is kept held, the pool experience value is decreased, and the character experience value of the selected character is increased, whereby the pool experience value is transferred to (converted into) the character experience value of the selected character. Then, when the player quits holding the enhancement button 218, the transfer of the pool experience value to the character experience value is also quit. Note that “1” in terms of the pool experience value corresponds to “1” in terms of the character experience value.

Then, when the character experience value necessary for advancing the level of the selected character to the next level has been transferred from the pool experience value, in the first list indication 216, the level of the selected character is raised by “1”, and depending on the raised level, the character experience value necessary for advancing the level of the selected character further to the next level, the hit points of the selected character, and the attacking ability of the selected character are updated.

In the example in FIG. 6, when the pool experience value is decreased from “4515” to “4488” in the pool-experience-value indication 206 and the character experience value necessary for advancing the level of character E to the next level becomes “0” in the first list indication 216, the current level of character E is raised from “3” to “4”. Then, the character experience value necessary for advancing the level of character E to the next level, i.e., level 5, is updated to “100”, the hit points are raised from “512” to “562”, and the attacking ability is raised from “124” to “144”.

Furthermore, when the enhancement button 218 is kept tapped or held even after the level is raised, the transfer of the pool experience value to the character experience value is continued. Then, when the current level of the selected character reaches the current maximum level thereof as a result of the transfer of the pool experience value to the character experience value of the selected character, the pool experience value is no longer transferred to the character experience value even if the enhancement button 218 is tapped or held.

As described above, in this embodiment, in the case where the pool experience value possessed by the player is greater than or equal to one, the pool experience value possessed by the player is transferred to the character experience value of a selected character, which makes it possible to raise the level of the selected character within the current maximum level as an upper limit.

Meanwhile, as shown in FIG. 7, in the over-limiting image 215, an image indicating the appearance of the selected character is displayed in a middle right part of the display area 200, and a second list indication 220 indicating various kinds of parameters of the selected character is displayed in a middle left part of the display area 200 on the basis of the content stored in the terminal character-information storage unit 57. In this embodiment, the following items of information are displayed in the second list indication 220: the number of times of over-limiting of the selected character; the current maximum level of the selected character; the duplicate number (the number of stacks) of the selected character (a specific indication); and the number of special items possessed by the player.

In the example in FIG. 7, in which the over-limiting image 215 for character E is displayed, the second list indication 220 indicates that the number of times of over-limiting of character E is “0”, the current maximum level of character E is “40”, the duplicate number of character E is “5”, and the number of special items possessed by the player is “2”.

Furthermore, in the over-limiting image 215, an over-limiting button 222 having a circular shape is displayed in a lower middle part of the display area 200. When the over-limiting button 222 is tapped (on the basis of a first input), in the case where the duplicate number of the selected character is greater than or equal to one, one is subtracted from each of the possessed number and the duplicate number of the selected character, five is added to the current maximum level of the selected character, and one is added to the number of times of over-limiting of the selected character.

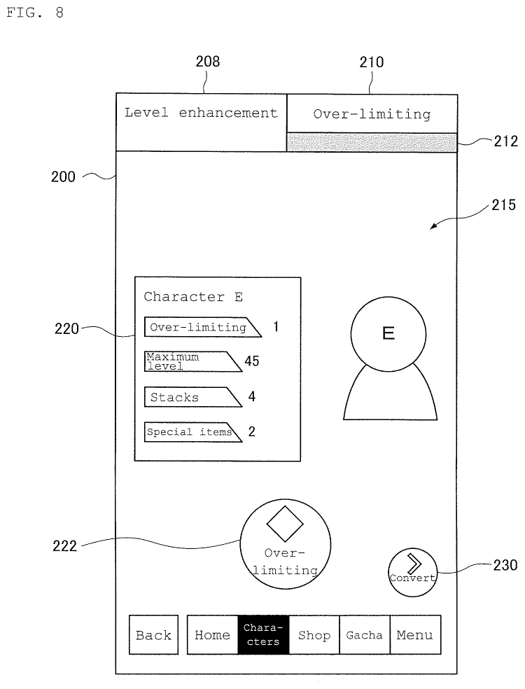

For example, when the over-limiting button 222 is tapped in the state shown in FIG. 7, as shown in FIG. 8, in the second list indication 220, the duplicate number of character E is decreased from “5” to “4”, the current maximum level of character E is increased from “40” to “45”, and the number of times of over-limiting thereof is increased from “0” to “1”.

Meanwhile, in the case where the duplicate number of the selected character is zero and the number of special items possessed by the player is greater than or equal to one, although not shown, one is subtracted from the number of special items possessed by the player, five is added to the current maximum level of the selected character, and one is added to the number of times of over-limiting of the selected character.

As described above, in this embodiment, in addition to accepting a player input for raising the current maximum level of the selected character by consuming a special item possessed by the player, it is possible to accept a player input for raising the current maximum level of the selected character by consuming the duplicate number of the selected character. Furthermore, in this embodiment, it is possible to accept a player input for raising the current maximum level of the selected character by first consuming the duplicate number of the selected character in the case where the duplicate number of the selected character is greater than or equal to one, even in the case where the number of special items possessed by the player is greater than or equal to one. Note that in this embodiment, regardless of the character for which over-limiting is performed by consuming a special item, or regardless of the character for which over-limiting is performed by consuming the duplicate number, the maximum level is increased by “5” when over-limiting is performed once.

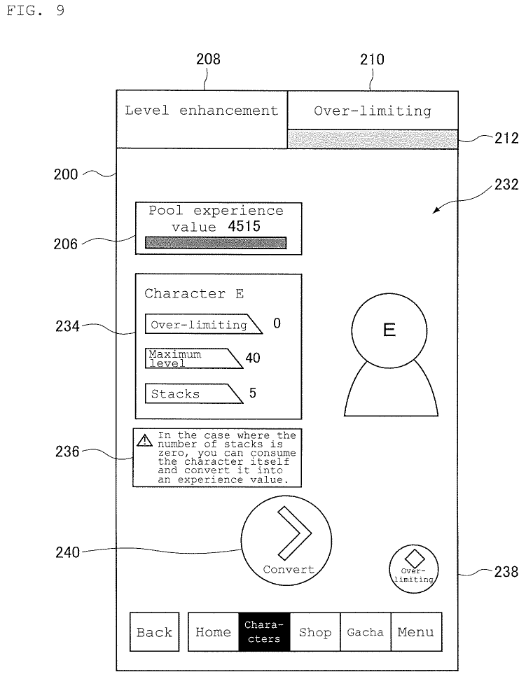

Furthermore, in the over-limiting image 215 shown in FIG. 7, a reduced conversion button 230 having a circular shape, which is smaller than the over-limiting button 222, is displayed in a lower right part of the display area 200. When the reduced conversion button 230 is tapped, as shown in FIG. 9, a pool-experience-value conversion image 232 is displayed, via which a player input for converting the duplicate number of the selected character or the selected character into a pool experience value is accepted.

As shown in FIG. 9, in the pool-experience-value conversion image 232, an image indicating the appearance of the character for which conversion into a pool experience value is to be performed is displayed in a middle right part of the display area 200, a pool-experience-value indication 206 indicating the pool experience value is displayed in an upper left part of the display area 200 on the basis of the content stored in the terminal player-information storage unit 58, and a third list indication 234 indicating various kinds of parameters of the selected character is displayed in a middle left part of the display area 200 on the basis of the content stored in the terminal character-information storage unit 57. In this embodiment, the following items of information are displayed in the third list indication 234: the number of times of over-limiting of the selected character; the current maximum level of the selected character; and the duplicate number (the number of stacks) of the selected character.

In the example in FIG. 9, in which the pool-experience-value conversion image 232 for character E is displayed, it is indicated that the pool experience value possessed by the player is “4515”, and the third list indication 234 indicates that the number of times of over-limiting of character E is “0”, the current maximum level of character E is “40”, and the duplicate number of character E is “5”.

Furthermore, in the pool-experience-value conversion image 232, a first explanation indication 236 is displayed under the third list indication 234, which explains that it is possible to convert a character into a pool experience value in the case where the duplicate number (the number of stacks) thereof is zero.

Furthermore, in the pool-experience-value conversion image 232, a reduced over-limiting button 238 having a circular shape is displayed in a lower right part of the display area 200. When the reduced over-limiting button 238 is tapped, the over-limiting image 215 shown in FIG. 7 is displayed.

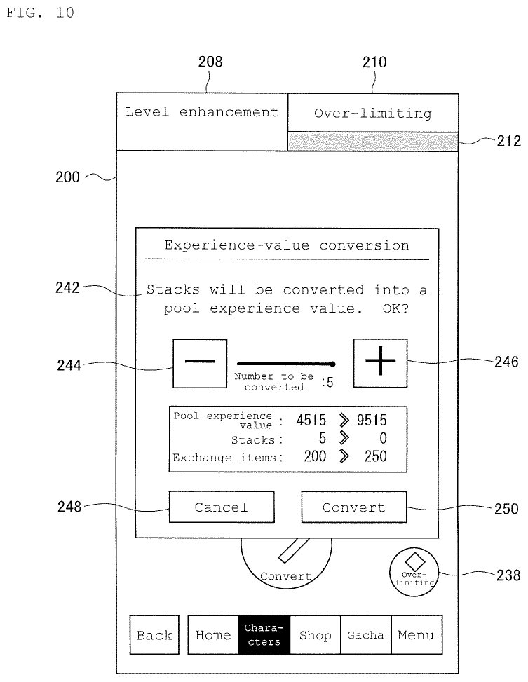

Furthermore, as shown in FIG. 9, in the pool-experience-value conversion image 232, a conversion button 240 having a circular shape is displayed in a lower middle part of the display area 200. When the conversion button 240 is tapped, in the case where the duplicate number of the selected character is greater than or equal to one, as shown in FIG. 10, a stack conversion image 242 for converting the duplicate number of the selected character into a pool experience value is displayed.

Specifically, in the stack conversion image 242, a minus button 244 and a plus button 246 are displayed. In the initial state, the conversion number, which is a duplicate number that is converted, is set to “0”. One is added to the conversion number each time the plus button 246 is tapped, and one is subtracted from the conversion number each time the minus button 244 is tapped. This makes it possible to specify a duplicate number to be converted into a pool experience value within the range of the duplicate number of the selected character.

Furthermore, in the stack conversion image 242, the current pool experience value as well as the pool experience value after the specified duplicate number is converted into a pool experience value are displayed, and the current duplicate number of the selected character as well as the duplicate number after the specified duplicate number is converted into a pool experience value are displayed. Furthermore, in this embodiment, when a duplicate number is converted into a pool value, exchange items are granted to the player depending on the kind of the selected character and the specified duplicate number. In the stack conversion image 242, the current number of exchange items as well as the number of exchange items after the specified duplicate number is converted into a pool experience value are displayed. Furthermore, in the stack conversion image 242, a cancel button 248 for cancelling the conversion of the specified duplicate number into a pool experience value and a stack-conversion determination button 250 for determining that the specified duplicate number be converted into a pool experience value are displayed.

In the example in FIG. 10, it is indicated that “5” is specified as a duplicate number to be converted into a pool experience value, that the current pool experience value is “4515”, and that the pool experience value after the specified duplicate number is converted into a pool experience value is “9515”, and it is indicated that the current duplicate number (the number of stacks) of the selected character is “5” and that the duplicate number after the specified duplicate number is converted into a pool experience value is “0”. Furthermore, it is indicated that the current number of exchange items of the player is “200” and that the number of exchange items after the duplicate number specified for the selected character is converted into a pool experience value is “250”.

Here, in this embodiment, the amount of pool experience value into which the duplicate number “1” of a character is converted varies depending on the rarity of that character: for a character with the rarity “5”, the duplicate number “1” is converted into the pool experience value “50000”; for a character with the rarity “4”, the duplicate number “1” is converted into the pool experience value “20000”; for a character with the rarity “3”, the duplicate number “1” is converted into the pool experience value “10000”; for a character with the rarity “2”, the duplicate number “1” is converted into the pool experience value “5000”; and for a character with the rarity “1”, the duplicate number “1” is converted into the pool experience value “1000”.

Accordingly, in the example in FIG. 10, for character E, having the rarity “1”, the duplicate number “1” is converted into the pool experience value “1000”, and thus the duplicate number “5” is converted into the pool experience value “5000”.

Furthermore, in this embodiment, the number of exchange items that are granted in the case where the duplicate number “1” of a character is converted into a pool experience value varies depending on the rarity of that character: for a character with the rarity “5”, “50” exchange items are granted when the duplicate number “1” is converted into a pool experience value; for a character with the rarity “4”, “40” exchange items are granted when the duplicate number “1” is converted into a pool experience value; for a character with the rarity “3”, “30” exchange items are granted when the duplicate number “1” is converted into a pool experience value; for a character with the rarity “2”, “20” exchange items are granted when the duplicate number “1” is converted into a pool experience value; and for a character with the rarity “1”, “10” exchange items are granted when the duplicate number “1” is converted into a pool experience value;

Accordingly, in the example in FIG. 10, for character E, having the rarity “1”, “10” exchange items are granted when the duplicate number “1” is converted into a pool experience value, and thus “50” exchange items are granted as a result of the duplicate number “5” being converted into a pool experience value.

Furthermore, when the stack-conversion determination button 250 is tapped (on the basis of a second input) in the state where the specified duplicate number is greater than or equal to one in the case where the stack conversion image 242 is displayed, a value obtained by multiplying the pool experience value corresponding to the rarity of the selected character by the specified duplicate number is added to the current pool experience value, and a value obtained by multiplying the number of exchange items corresponding to the rarity of the selected character by the specified duplicate number is added to the current number of exchange items. Furthermore, the specified duplicate number is subtracted from each of the possessed number and the duplicate number of the selected character.

In the example in FIG. 10, “5000” obtained by multiplying the pool experience value “1000” corresponding to the rarity of character E by the specified duplicate number “5” is added to the current pool experience value “4515”, whereby the pool experience value is increased to “9515”. Furthermore, “50” obtained by multiplying the number of exchange items “10” corresponding to the rarity of character E by the specified duplicate number “5” is added to the current number of exchange items “200”, whereby the number of exchange items is increased to “250”. Furthermore, the specified duplicate number “5” is subtracted from the possessed number “6” of character E, whereby the possessed number of character E is decreased to “1”. Furthermore, the specified duplicate number “5” is subtracted from the duplicate number “5” of character E, whereby the duplicate number of character E is decreased to “0”.

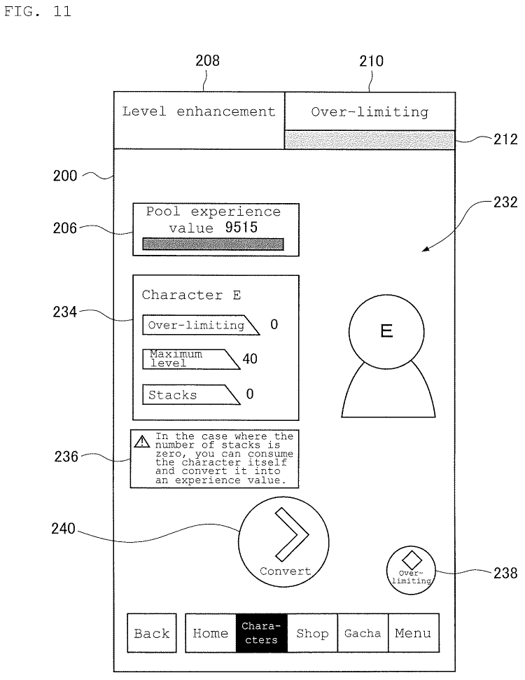

Then, as shown in FIG. 11, the pool-experience-value conversion image 232 is displayed again, in which the updated pool experience value is displayed in the pool-experience-value indication 206, and the updated duplicate number (the number of stacks) of the selected character is displayed in the third list indication 234. In the example in FIG. 11, the pool-experience-value indication 206 indicates that the pool experience value possessed by the player is “9515”, and the third list indication 234 indicates that the duplicate number of character E is “0”. Note that the number of exchange items is not displayed in the pool-experience-value conversion image 232 but is displayed in an image that is displayed in the shop mode.

As described above, in this embodiment, in the case where the duplicate number of a selected character is greater than or equal to one, it is possible to convert the duplicate number of the selected character into a pool experience value until the duplicate number of the selected character becomes zero.

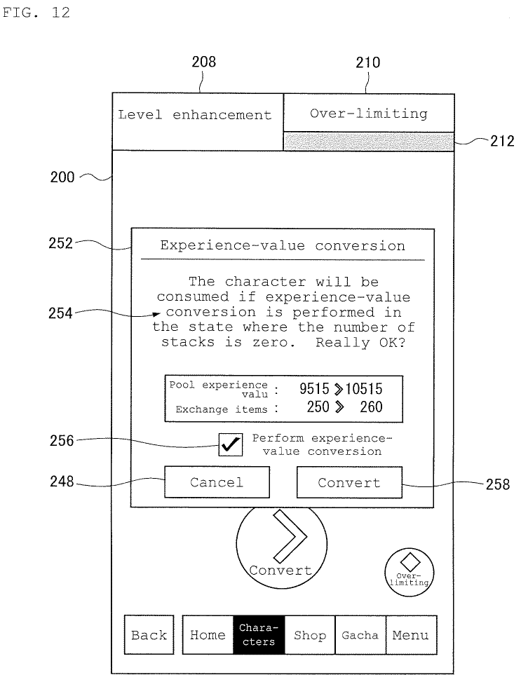

Furthermore, in this embodiment, as shown in FIG. 11, in the case where the duplicate number of the selected character is zero, i.e., in the case where the possessed number of the selected character is one, when the conversion button 240 is tapped, as shown in FIG. 12, a character conversion image 252 for converting the selected character into a pool experience value is displayed.

Specifically, in the character conversion image 252, a warning indication 254 is displayed, warning that the character is consumed if conversion into a pool experience value is performed in the state where the duplicate number (the number of stacks) is zero, and the current pool experience value as well as the pool experience value after the selected character is converted into a pool experience value are displayed. Furthermore, the current number of exchange items as well as the number of exchange items after the selected character is converted into a pool experience value are displayed.

In the example in FIG. 12, it is indicated that the current pool experience value is “9515” and that the pool experience value after the selected character is converted into a pool experience value is “10515”. Furthermore, it is indicated that the current number of exchange items is “250” and the number of exchange items after the selected character is converted into a pool experience value is “260”.

Here, in this embodiment, with characters having the same rarity, the pool experience value into which the duplicate number “1” is converted and the pool experience value into which the character is converted are the same. For example, with character E, having the rarity “1”, the result of conversion is the pool experience value “1000” either in the case where the duplicate number “1” is converted or in the case where character E is converted. Furthermore, with characters having the same rarity, the number of exchange items that are granted as a result of the duplicate number “1” being converted into a pool experience value and the number of exchange items that are granted as a result of the character being converted into a pool experience value are the same. For example, with character E, having the rarity “1”, “10” exchange items are granted either in the case where the duplicate number “1” is converted into a pool experience value or in the case where character E is converted into a pool experience value.

Furthermore, in the character conversion image 252, a checkbox 256 for confirming that the selected character be converted into a pool experience value is displayed. Furthermore, a cancel button 248 for cancelling the conversion of the selected character into a pool experience value and a character-conversion determination button 258 for determining that the selected character be converted into a pool experience value are displayed.

Furthermore, in the initial state of the character conversion image 252, no checkmark is displayed in the checkbox 256. When the checkbox 256 is tapped, a checkmark is displayed in the checkbox 256. When the character-conversion determination button 258 is tapped in the state where a checkmark is displayed in the checkbox 256, the pool experience value corresponding to the rarity of the selected character is added to the current pool experience value, and one is subtracted from the possessed number of the selected character. Furthermore, the number of exchange items corresponding to the rarity of the selected character is added to the current number of exchange items.

In the example in FIG. 12, the pool experience value “1000” corresponding to the rarity of character E is added to the current pool experience value “9515”, whereby the pool experience value is increased to “10515”, and the possessed number of character E is decreased from “1” to “0”. Furthermore, the number of exchange items “10” corresponding to the rarity of character E is added to the current number of exchange items “250”, whereby the number of exchange items is increased to “260”.

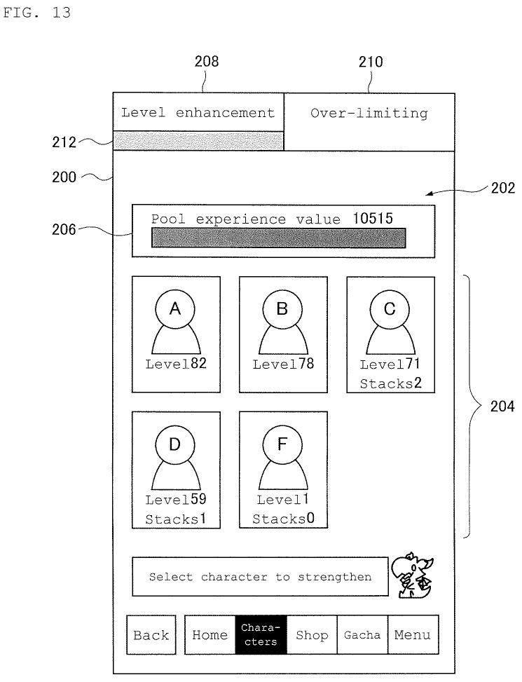

Then, as shown in FIG. 13, the character-to-strengthen selection image 202 is displayed again, in which the updated pool experience value is displayed in the pool-experience-value indication 206. Since various kinds of parameters of the character converted into a pool experience value are reset to initial values in the server character-information storage unit 22 and the terminal character-information storage unit 57 shown in FIG. 4, in the character-to-strengthen selection image 202, the character button 204 corresponding to the character converted into a pool experience value is not displayed, and it is not allowed to let the character participate in the player party.

In the example in FIG. 13, the pool-experience-value indication 206 indicates that the pool experience value possessed by the player is “10515”, and the character button 204 corresponding to character E is deleted. Note that in this embodiment, with a character participating in the player party, it is not allowed to convert the character into a pool experience value.

As described above, in this embodiment, it is possible to accept a player input for converting the duplicate number of a character possessed by the player into a pool experience value, and it is possible to accept a player input for converting a character with which the possessed number is one and the duplicate number is zero into a pool experience value.

Furthermore, in this embodiment, in the stack conversion image 242 shown in FIG. 10, it is possible to convert the duplicate number of the selected character into a pool experience value, but it is not possible to convert the selected character into a pool experience value. As shown in FIG. 11, in the case where the conversion button 240 is tapped in the pool-experience-value conversion image 232 in the state where the duplicate number of the selected character is zero, the character conversion image 252 shown in FIG. 12 is displayed, and it is possible to convert the selected character into a pool experience value by tapping the character-conversion determination button 258 in the state where a checkmark is displayed in the checkbox 256 in the character conversion image 252.

Accordingly, in this embodiment, it is possible to prevent the player from converting a selected character into a pool experience value by mistake.

As described above, in this embodiment, a plurality of character buttons 204 corresponding to the same character are not displayed in the character-to-strengthen selection image 202 shown in FIG. 5, and the player can recognize the duplicate number of each character in the character-to-strengthen selection image 202 shown in FIG. 5, the over-limiting image 215 shown in FIG. 7, the pool-experience-value conversion image 232 shown in FIG. 9, etc.

Furthermore, in this embodiment, the player can perform over-limiting by consuming the duplicate number of a selected character, can convert the duplicate number of a selected character into a pool experience value by consuming the duplicate number, and can convert a selected character itself into a pool experience value by consuming the selected character. Furthermore, exchange items are granted when the duplicate number of a selected character or a selected character itself is consumed for conversion into a pool experience value.

As described above, in this embodiment, each character with which a player possesses duplicates is managed in the form of the duplicate number. Even if a character that is the same as one of the characters possessed by the player is granted through a lottery or a character that is considered by the player as being unnecessary is granted through a lottery, it is possible to effectively utilize the character with which the player possesses duplicates or the character that is considered by the player as being unnecessary. Thus, it is possible to realize an interface that makes it easy for the player to manage characters even if the number of characters possessed by the player increases.

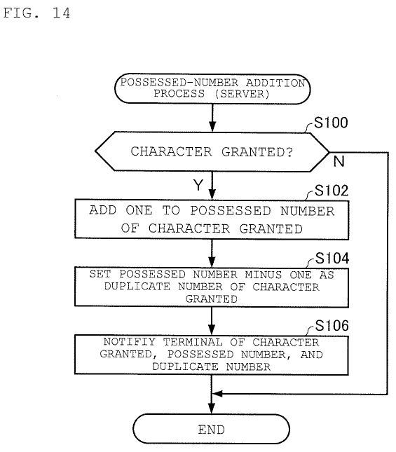

The following describes the flows of processes that are performed at the server device 12 or the terminal device 14 in this embodiment, with reference to flowcharts in FIGS. 14 to 18.

FIG. 14 is a flowchart showing the flow of a possessed-number addition process that is performed at the server device 12. In the possessed-number addition process shown in FIG. 14, at the server device 12, the server parameter update unit 46 determines whether or not a character has been granted through a lottery or the like (step S100). In the case where a character has been granted (Y in step S100), in the server character-information storage unit 22, one is added to the possessed number of the character granted (step S102), and the value obtained by subtracting one from the possessed number is set as the duplicate number of the character granted (step S104). Then, the server communication control unit 48 (a lottery-information transmission unit) notifies the terminal device 14 of the identification information, the possessed number, and the duplicate number of the character granted (step S106).

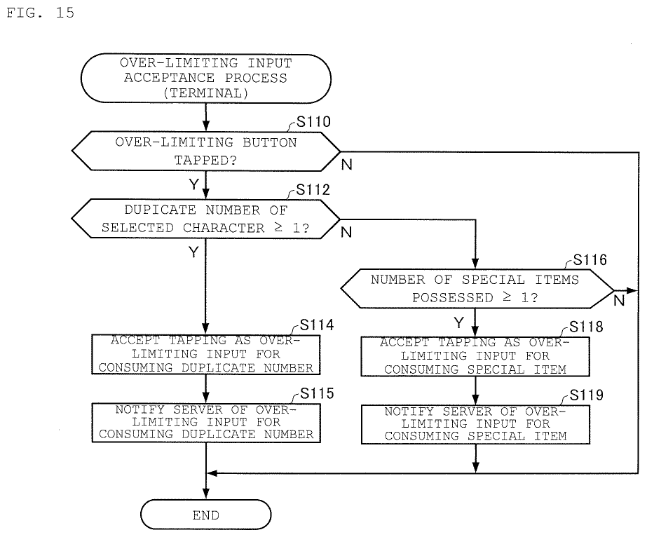

FIG. 15 is a flowchart showing the flow of an over-limiting input acceptance process that is performed at the terminal device 14. In the over-limiting input acceptance process shown in FIG. 15, at the terminal device 14, the input acceptance unit 103 determines whether or not the over-limiting button 222 shown in FIG. 7 has been tapped (step S110). In the case where the over-limiting button 222 has been tapped (Y in step S110), the input acceptance unit 103 determines whether or not the duplicate number of the selected character is greater than or equal to one (step S112). In the case where the duplicate number of the selected character is greater than or equal to one (Y in step S112), the input acceptance unit 103 accepts the tapping as an over-limiting input for consuming the duplicate number of the selected character (step S114). Then, the terminal communication control unit 112 (a player-input transmission unit) notifies the server device 12 of the acceptance of the over-limiting input for consuming the duplicate number of the selected character (step S115).

Meanwhile, in the case where the duplicate number of the selected character is not greater than or equal to one (N in step S112), the input acceptance unit 103 determines whether or not the number of possessed special items is greater than or equal to one (step S116). In the case where the number of possessed special items is greater than or equal to one (Y in step S116), the input acceptance unit 103 accepts the tapping as an over-limiting input for consuming a special item (step S118). Then, the terminal communication control unit 112 notifies the server device 12 of the acceptance of the over-limiting input for consuming a special item (step S119).

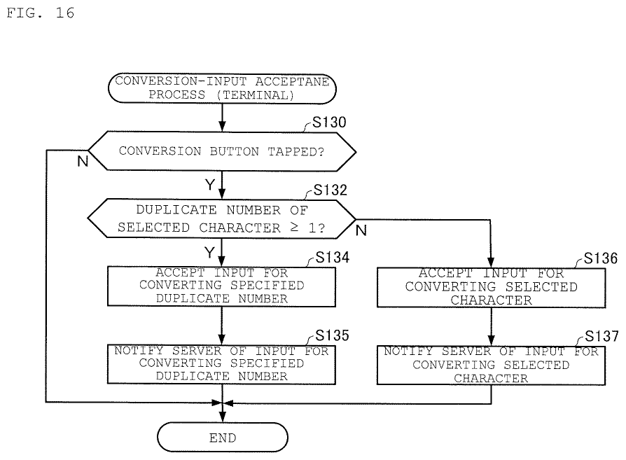

FIG. 16 is a flowchart showing the flow of a conversion-input acceptance process that is performed at the terminal device 14. In the conversion-input acceptance process shown in FIG. 16, at the terminal device 14, the input acceptance unit 103 determines whether or not the conversion button 240 shown in FIG. 9 has been tapped (step S130). In the case where the conversion button 240 has been tapped (Y in step S130), the input acceptance unit 103 determines whether or not the duplicate number of the selected character is greater than or equal to one (step S132). In the case where the duplicate number of the selected character is greater than or equal to one (Y in step S132), the input acceptance unit 103 causes the stack conversion image 242 shown in FIG. 10 to be displayed and accepts a conversion input for converting a specified duplicate number into a pool experience value (step S134). Then, the terminal communication control unit 112 notifies the server device 12 of the acceptance of the conversion input for converting the specified duplicate number into a pool experience value (step S135).

Meanwhile, in the case where the duplicate number of the selected character is not greater than or equal to one (N in step S132), the input acceptance unit 103 causes the character conversion image 252 shown in FIG. 12 to be displayed and accepts a conversion input for converting the selected character into a pool experience value (step S136). Then, the terminal communication control unit 112 notifies the server device 12 of the acceptance of the conversion input for converting the selected character into a pool experience value (step S137).

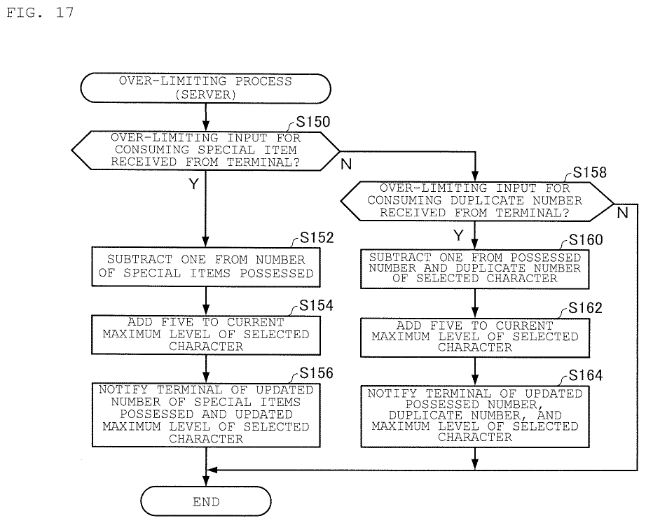

FIG. 17 is a flowchart showing the flow of an over-limiting process that is performed at the server device 12. In the over-limiting process shown in FIG. 17, when an over-limiting input for consuming a special item has been received from the terminal device 14 by the server communication control unit 48 (Y in step S150), the server parameter update unit 46 subtracts one from the number of special items possessed by the player in the server player-information storage unit 24 (step S152), and adds five to the current maximum level of the selected character in the server character-information storage unit 22 (step S154). Then, the server communication control unit 48 notifies the terminal device 14 of the updated number of special items possessed by the player and the updated maximum level of the selected character (step S156).

Meanwhile, when an over-limiting input for consuming the duplicate number has been received from the terminal device 14 by the server communication control unit 48 (Y in step S158), the server parameter update unit 46 subtracts one from each of the possessed number and the duplicate number of the selected character in the server character-information storage unit 22 (step S160), and adds five to the current maximum level of the selected character (step S162). Then, the server communication control unit 48 notifies the terminal device 14 of the updated possessed number and duplicate number of the selected character and the updated maximum level (step S164).

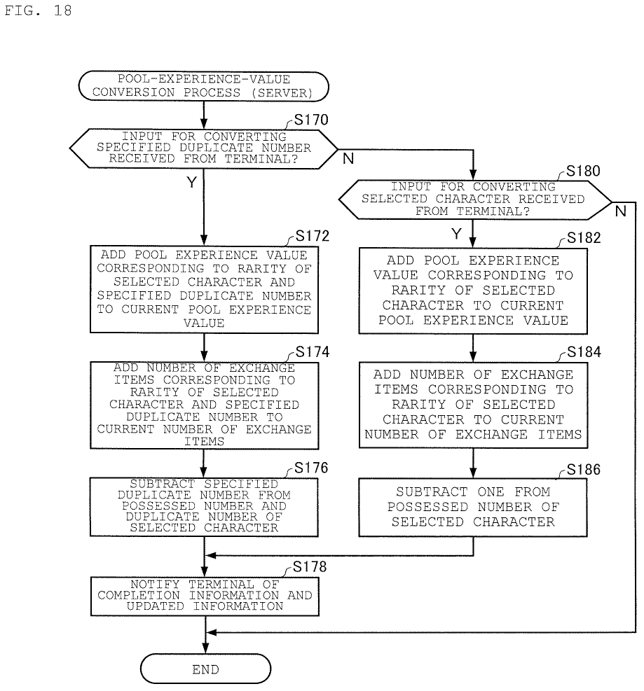

FIG. 18 is a flowchart showing the flow of a pool-experience-value conversion process that is executed at the server device 12. In the pool-experience-value conversion process shown in FIG. 18, when a conversion input for converting a specified duplicate number into a pool experience value has been received from the terminal device 14 by the server communication control unit 48 (Y in step S170), in the server player-information storage unit 24, a pool experience value corresponding to the rarity of the selected character and the specified duplicate number is added to the current pool experience value (step S172), and the number of exchange items corresponding to the rarity of the selected character and the specified duplicate number is added to the current number of exchange items (step S174). Furthermore, in the server character-information storage unit 22, the specified duplicate number is subtracted from each of the possessed number and the duplicate number of the selected character (step S176). Then, the server communication control unit 48 notifies the terminal device 14 of information indicating the completion of the pool-experience-value conversion process, the updated pool experience value and the updated number of exchange items, and the updated possessed number and duplicate number of the selected character (step S178).

Meanwhile, when a conversion input for converting a selected character into a pool experience value has been received from the terminal device 14 by the server communication control unit 48 (Y in step S180), in the server player-information storage unit 24, a pool experience value corresponding to the rarity of the selected character is added to the current pool experience value (step S182), and the number of exchange items corresponding to the rarity of the selected character is added to the current number of exchange items (step S184). Furthermore, in the server character-information storage unit 22, one is subtracted from the possessed number of the selected character (step S186). Then, the server communication control unit 48 notifies the terminal device 14 of information indicating the completion of the pool-experience-value conversion process, the updated pool experience value and the updated number of exchange items, and the updated possessed number and duplicate number of the selected character (step S178).

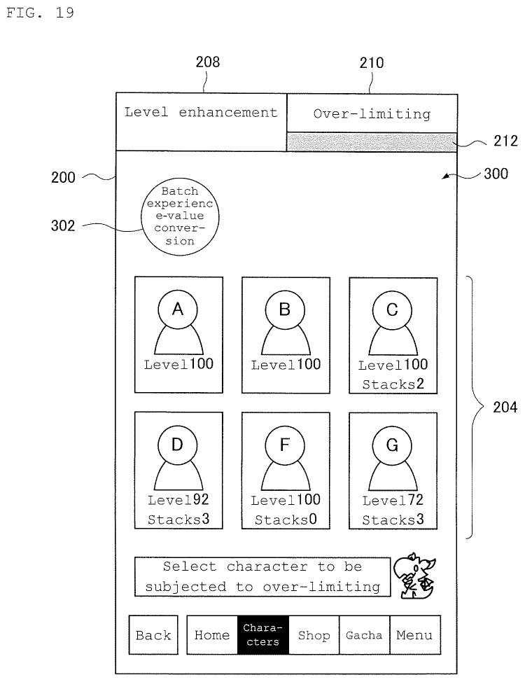

FIG. 19 shows, among game images in the character mode, an example over-limiting character selection image 300 for selecting a character for which over-limiting is to be performed from among the characters possessed by the player. As shown in FIG. 19, in the over-limiting character selection image 300, a selection indication 212 is displayed in a lower part of an over-limiting selection button 210. Furthermore, similarly to the character-to-strengthen selection image 202 described earlier, for each character with which the possessed number is greater than or equal to one, one character button 204 corresponding to that character is displayed.

Here, in this embodiment, as described earlier, it is possible to consume the duplicate number of a selected character, or a selected character itself, and to convert the duplicate number or the selected character into a pool experience value. In the case where the duplicate number or a character is consumed and is converted into a pool experience value for each of a plurality of characters, there is a concern that the work of selecting a character in the character-to-strengthen selection image 202 shown in FIG. 19 and causing the pool-experience-value conversion image 232 shown in FIG. 9 to be displayed for each of the plurality of characters may be perceived as being laborious.

However, in the case where a character with the duplicate number zero is consumed and is converted into a pool experience value, a character that is not possessed by the player is consumed. Furthermore, with a character whose maximum level has not reached the upper-limit value of one hundred, there are many players who prefers performing over-limiting to consuming the duplicate number and converting the duplicate number into a pool experience value. Thus, conversion into a pool experience value should preferably be performed carefully for characters with the duplicate number zero and characters whose maximum levels have not reached the upper-limit value of one hundred.

Accordingly, in this embodiment, a batch experience-value conversion is performed on the basis of a player input, in which all the duplicate numbers for individual subject characters are converted into a pool experience value, where, among the character possessed by the player, all the characters whose duplicate numbers are greater than or equal to one and whose maximum levels have reached the upper-limit value of one hundred (specific game media) are considered as the subject characters.

Specifically, in this embodiment, as shown in FIG. 19, in the over-limiting character selection image 300, a batch experience-value conversion button 302 is displayed above the plurality of character buttons 204. Furthermore, when the batch experience-value conversion button 302 is tapped (on the basis of a third input) at the terminal device 14, the tapping is accepted as a start input for starting batch experience-value conversion, and the server device 12 is notified of the acceptance of the start input for batch experience-value conversion. Then, subject characters are extracted at the server device 12, and the terminal device 14 is notified of the identification information of the subject characters.

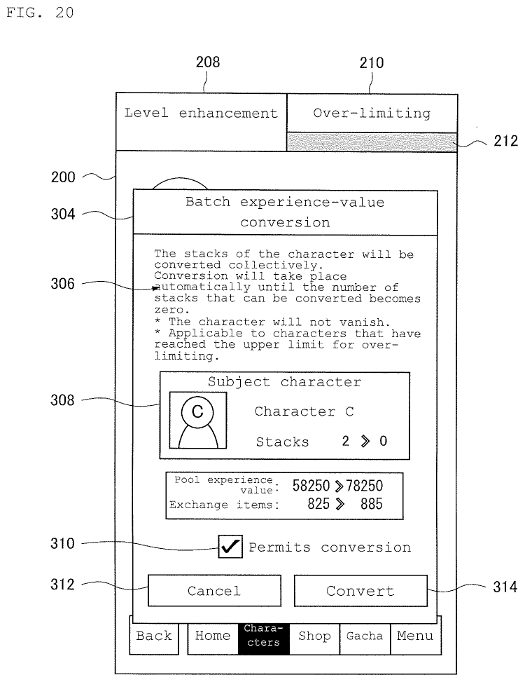

In the example in FIG. 19, character C is a subject character because the duplicate number is greater than or equal to one, the maximum level has reached one hundred, and the level has also reached one hundred. Character D is s subject character because the duplicate number is greater than or equal to one, the level has not reached one hundred, but the maximum level has reached one hundred. Meanwhile, character A, character B, and character F are not subject characters because even though the maximum levels have reached one hundred and the levels have also reached one hundred, the duplicate numbers are not greater than or equal to one. Furthermore, character G is not a subject character because even though the duplicate number is greater than or equal to one, the maximum level has not reached one hundred. Furthermore, at the terminal device 14, on the basis of the identification information of the subject characters, a batch conversion image 304 shown in FIG. 20 is displayed in the display area 200 for each of the subject characters.

As shown in FIG. 20, in the batch conversion image 304, a second explanation indication 306 is displayed, explaining that the duplicate numbers (the numbers of stacks) of the characters possessed by the player will be converted collectively, that the conversion will take place automatically until the stacks that can be converted becomes zero (the initial value), that the characters will not be consumed, and that the subjects are the characters whose maximum levels have reached the upper-limit value.

Furthermore, a subject-character indication 308 indicating a subject character is displayed under the second explanation indication 306. In this embodiment, one batch conversion image 304 is displayed for one subject character. In the batch conversion image 304 in the example in FIG. 20, character C is displayed as the first subject character in the subject-character indication 308. Furthermore, under the subject-character indication 308, the current pool experience value, as well as the pool experience value after batch experience-value conversion is performed for the first subject character, are displayed. Furthermore, the current number of exchange items, as well as the number of exchange items after batch experience-value conversion is performed for the first character, are displayed.

In the batch conversion image 304 for the first subject character, shown in FIG. 20, it is indicated that the current pool experience value is “58250” and that the pool experience value after batch experience-value conversion is performed for the first subject character is “78250”. Furthermore, it is indicated that the current number of exchange items is “825” and that the number of exchange items after batch experience-value conversion is performed for the first subject character is “885”.

Furthermore, in the batch conversion image 304 for the first subject character, a checkbox 310 for confirming that batch experience-value conversion is to be performed for the first subject character is displayed. Furthermore, a cancel button 312 for cancelling batch experience-value conversion for the first subject character and a batch-conversion determination button 314 for determining that batch experience-value conversion be performed for the first subject character are displayed.

Furthermore, in the initial state of the batch conversion image 304, no checkmark is displayed in the checkbox 310. When the checkbox 310 has been tapped, a checkmark is displayed in the checkbox 310. When the batch-conversion determination button 314 has been tapped (on the basis of a third input) at the terminal device 14 in the state where a checkmark is displayed in the checkbox 310, the tapping is accepted as a permission input for permitting batch experience-value conversion for the first subject character, and the server device 12 is notified of the identification information of the first subject character and the acceptance of the permission input for batch experience-value conversion.

Then, batch experience-value conversion is performed for the first subject character at the server device 12. Specifically, a pool experience value corresponding to the rarity and the duplicate number of the first subject character is added to the current pool experience value, and the number of exchange items corresponding to the rarity and the duplicate number of the first subject character is added to the current number of exchange items. Furthermore, the duplicate number of the first subject character is subtracted from each of the possessed number and the duplicate number of the first subject character.

In the example in FIG. 20, “2000” obtained by multiplying the pool experience value “10000” corresponding to the rarity of character C by the current duplicate number “2” of character C is added to the current pool experience value “58250”, whereby the pool experience value is increased to “78250”, the possessed number of character C is decreased from “3” to “1”, and the duplicate number of character C is decreased from “2” to “0”. Furthermore, “60” obtained by multiplying the number of exchange items “30” corresponding to the rarity of character C by the current duplicate number “2” of character C is added to the current number of exchange items “825”, whereby the number of exchange items is increased to “885”.

Meanwhile, when the cancel button 312 has been tapped, the tapping is accepted as a cancelling input for cancelling batch experience-value conversion for the first subject character, and the server device 12 is notified of the acceptance of the cancelling input for batch experience-value conversion for the first subject character. Then, batch experience-value conversion for the first subject character is not performed at the server device 12.

Furthermore, regardless of whether the cancel button 312 is tapped or the batch-conversion determination button 314 is tapped in the batch conversion image 304 for the first subject character, in the case where the second subject character exists, the batch conversion image 304 for the second subject character is displayed after erasing the batch conversion image 304 for the first subject character. In the example in FIG. 19, since character D is the second subject character, when the batch conversion image 304 for character C in the example in FIG. 20 has been deleted, although not shown, a batch conversion image 304 in which character D is displayed in the subject-character indication 308 as the second subject character is displayed.

Furthermore, in the case where the batch-conversion determination button 314 has been tapped in the batch conversion image 304 for the first subject character, whereby batch experience-value conversion has been performed for the first subject character, in the batch conversion image 304 for the second subject character, the current pool experience value, i.e., the pool experience value after batch experience-value conversion is performed for the first subject character, as well as the pool experience value after batch experience-value conversion is performed for the second subject character, are displayed. Furthermore, the current number of exchange items, i.e., the number of exchange items after batch experience-value conversion is performed for the first subject character, as well as the number of exchange items after batch experience-value conversion is performed for the second subject character, are displayed.

Meanwhile, when the cancel button 312 has been tapped in the batch conversion image 304 for the first subject character, whereby batch experience-value conversion has not been performed for the first subject character, in the batch conversion image 304 for the second subject character, the current pool experience value, i.e., the pool experience value at the timing of tapping of the cancel button 312 in the batch conversion image 304 for the first subject character, as well as the pool experience value after batch experience- value conversion is performed for the second subject character, are displayed. Furthermore, the current number of exchange items, i.e., the number of exchange items at the timing of tapping of the cancel button 312 in the batch conversion image 304 for the first subject character, as well as the number of exchange items after batch experience-value conversion is performed for the second subject character, are displayed.

Furthermore, in the batch conversion image 304 for the second subject character, a checkbox 310 for confirming that batch experience-value conversion be performed for the second subject character is displayed. Furthermore, a cancel button 312 for cancelling batch experience-value conversion for the second subject character and a batch-conversion determination button 314 for determining that batch experience-value conversion be performed for the second subject character are displayed.

Furthermore, when the batch-conversion determination button 314 has been tapped (on the basis of a third input) at the terminal device 14 in the state where a checkmark is displayed in the checkbox 310, the tapping is accepted as a permission input for permitting batch experience-value conversion for the second subject character, and the server device 12 is notified of the identification information of the second subject character and the acceptance of the permission input for batch experience-value conversion.

Then, batch experience-value conversion is performed for the second subject character at the server device 12. Specifically, a pool experience value corresponding to the rarity and the duplicate number of the second subject character is added to the current pool experience value, i.e., the pool experience value after batch experience-value conversion is performed for the first subject character, and the number of exchange items corresponding to the rarity and the duplicate number of the second subject character is added to the current number of exchange items, i.e., the number of exchange items after batch experience-value conversion is performed for the first subject character. Furthermore, the duplicate number of the second subject character is subtracted from each of the possessed number and the duplicate number of the second subject character.

Although not shown, in the case where the second subject character is character D, “15000” obtained by multiplying the pool experience value “5000” corresponding to the rarity of character D by the current duplicate number “3” of character D is added to the current pool experience value, i.e., the pool experience value “78250” after batch experience-value conversion is performed for the first subject character, whereby the pool experience value is increased to “93250”, the possessed number of character D is decreased from “4” to “1”, and the duplicate number of character D is decreased from “3” to “0”. Furthermore, “60” obtained by multiplying the number of exchange items “20” corresponding to the rarity of character D by the current duplicate number “3” of character D is added to the current number of exchange items, i.e., the number of exchange items “885” after batch experience-value conversion is performed for the first subject character, whereby the number of exchange items is increased to “945”.

Meanwhile, when the cancel button 312 has been tapped, the tapping is accepted as a cancelling input for cancelling batch experience-value conversion for the second subject character, and the server device 12 is notified of the acceptance of the cancelling input for batch experience-value conversion for the second subject character. Then, batch experience-value conversion for the second subject character is not performed at the server device 12.

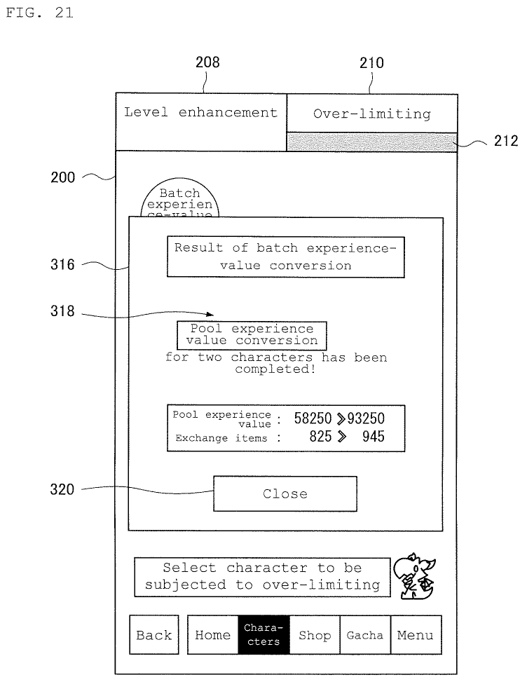

Furthermore, regardless of whether the cancel button 312 is tapped or the batch-conversion determination button 314 is tapped in the batch conversion image 304 for the second subject character, in the case where the next subject character does not exist, a batch-conversion result image 316 shown in FIG. 21 is displayed in the display area 200 after erasing the batch conversion image 304 for the last subject character. In the batch-conversion result image 316, a batch-conversion-number indication 318 is displayed, indicating the number of characters subjected to batch experience-value conversion. In the batch-conversion-number indication 318 in the example in FIG. 21, since batch experience-value conversion has been performed for character C and character D, it is indicated that the number of characters subjected to batch experience-value conversion is two.

Furthermore, under the batch-conversion-number indication 318, the pool experience value before batch experience-value conversion is performed for each subject character and the pool experience value after batch experience-value conversion is performed for each subject character are displayed. Furthermore, the number of exchange items before batch experience-value conversion is performed for each subject character and the number of exchange items after batch experience-value conversion is performed for each subject character are displayed.

In the example in FIG. 21, it is indicated that the pool experience value before batch experience-value conversion is performed for each subject character is “58250” and that the pool experience value after batch experience-value conversion is performed for each subject character is “93250”. Furthermore, it is indicated that the number of exchange items before batch experience-value conversion is performed for each subject character is “825” and that the number of exchange items after batch experience-value conversion is performed for each subject character is “945”.

Furthermore, when a close button 320 displayed in a lower part of the batch-conversion result image 316 has been tapped, the batch-conversion result image 316 is erased, and the over-limiting character selection image 300 shown in FIG. 19 is displayed in the display area 200.

Note that in the case where the cancel button 312 has been tapped in the batch conversion image 304 for all the subject characters, the batch-conversion result image 316 is not displayed, and the over-limiting character selection image 300 is displayed in the display area 200.

As described above, in this embodiment, when the player has tapped the batch experience-value conversion button 302, the batch conversion images 304 for the individual subject characters are sequentially displayed, which makes it possible for the player to convert the whole duplicate number into a pool experience values on a per-subject-character basis, while choosing whether or not to perform batch experience-value conversion on a per-subject-character basis.

Accordingly, in this embodiment, it is possible to automatically consume the whole duplicate number and to convert the duplicate number into a pool experience value for each of a plurality of characters, while saving the labor of selecting a character in the over-limiting character selection image 300 shown in FIG. 19 and displaying the pool-experience-value conversion image 232 shown in FIG. 9 for each of the plurality of characters.

As described above, in this embodiment, it is possible, with simple inputs, to effectively utilize characters with which a player possesses duplicates. Thus, it is possible to realize an interface that makes it easy for the player to manage characters even when the number of characters possessed by the player increases.

Furthermore, in this embodiment, exchange items are granted when the duplicate number of a selected character or a selected character itself is consumed and is converted into a pool experience value. This makes it possible to enhance the player's motivation for consuming the duplicate number of a selected character or a selected character itself and converting the duplicate number or the selected character into a pool experience value.

Here, as described earlier, the number of exchange items is increased also in the case where other various kinds of conditions are satisfied. Specifically, in this embodiment, specific lottery processing, which is a kind of lottery processing, is performed on a limited period basis. In the specific lottery processing, characters with the rarity “5” are the subjects of the lottery; however, since the probabilities of the characters with the rarity “5” being determined are set to be very low, and thus there are cases where no character with the rarity “5” wins and is granted to the player even if the specific lottery processing is repeated many times.

Thus, it is arranged such that two for-charge exchange items are granted to the player each time some lottery processing is performed on condition of the consumption of a for-charge in-game currency or a for-charge item and such that when the number of for-charge exchange items accumulated has reached a prescribed number, it is allowed to exchange the prescribed number of for-charge exchange points for a character with the rarity “5”, which is a subject of the lottery in the specific lottery processing.

However, since for-charge exchange items are not granted in the case where lottery processing is performed on condition of the consumption of a for-free in-game currency, a for-free item, or a for-free ticket. Thus, it has been necessary for a player who performs lottery processing on condition of the consumption of a for-free in-game currency or the like to perform the specific lottery processing until a character with the rarity “5” is determined in the specific lottery processing.

Thus, in this embodiment, it is arranged such that regardless of whether the specific lottery processing is performed on condition of the consumption of a for-charge in-game currency or a for-charge item or the specific lottery processing is performed on condition of the consumption of a for-free in-game currency or the like, an exchange point worth one point is granted to the player each time the specific lottery processing is performed once and such that when the exchange points accumulated have reached a prescribed number, it is allowed to exchange the prescribed number of exchange points for a character with the rarity “5”, which is a subject of the lottery in the specific lottery processing. Note that the number of exchange points and the number of for-charge exchange items are displayed in a game image in the lottery mode.

Here, exchange points are associated with the specific lottery processing through which the exchange points were granted. When the period in which the specific lottery processing can be performed is over, the exchange points granted through the specific lottery processing become invalid. In this embodiment, the exchange points that have become invalid are converted into exchange items that do not become invalid as a result of the elapse of the period, and the result is added to the current number of exchange items.

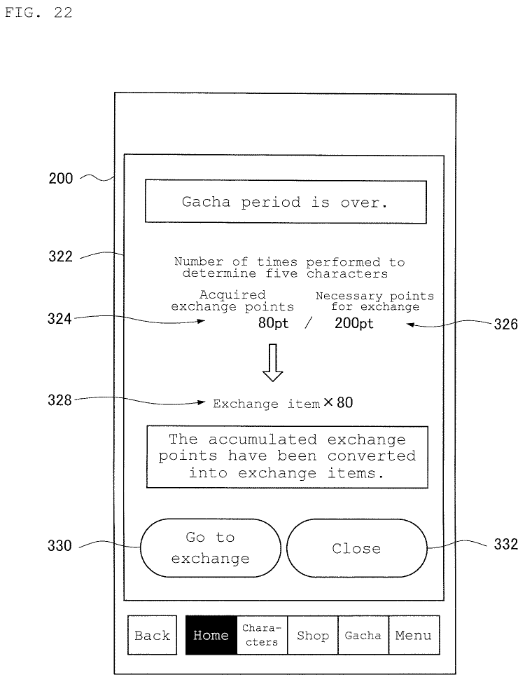

FIG. 22 is an illustration showing an example period-over image 322 that is displayed in the display area 200 when the period of the specific lottery processing is over. As shown in FIG. 22, in the period-over image 322, a number-of-acquired-exchange-points indication 324 indicating the number of exchange points granted through the specific lottery processing, as well as a necessary-number-for-exchange indication 326 indicating the number of exchange points necessary for exchange for a character with the rarity “5”, which is a subject of the lottery in the specific lottery processing, are displayed. Furthermore, under the number-of-acquired-exchange-points indication 324, a number-of-exchange-item indication 328 indicating the number of exchange items into which exchange points have been converted is displayed. In the example in FIG. 22, 80 exchange points are converted into 80 exchange items, and the result is added to the current number of exchange items.

Furthermore, when an exchange button 330 displayed in a lower part of the period-over image 322, the shop mode is executed, whereby an exchange image for selecting a character or item for exchange with exchange items is displayed, in which the updated number of exchange items is displayed. Meanwhile, when a close button 332 has been tapped, the period-over image 322 is erased, and a home image is displayed.

As described above, in this embodiment, exchange points that have become invalid are converted into exchange items, which enhances player's motivation for performing the specific lottery processing.

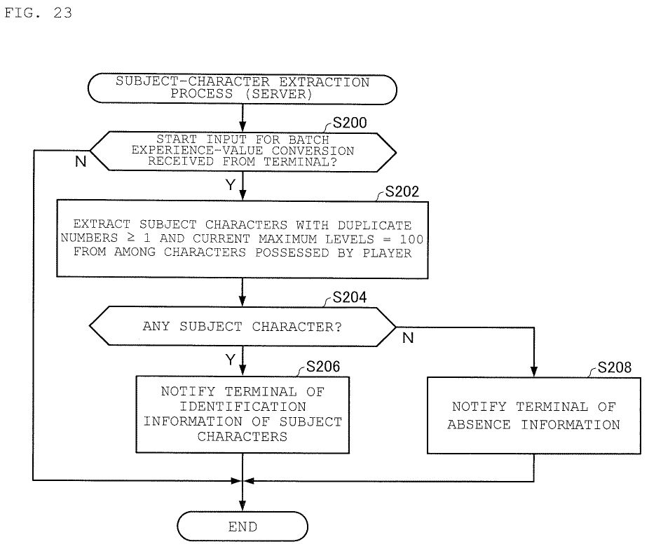

The following describes the flows of processes that are performed at the server device 12 or the terminal device 14 when batch experience-value conversion is performed, with reference to flowcharts in FIGS. 23 to 25.

FIG. 23 is a flowchart showing the flow of a subject-character extraction process that is performed at the server device 12. In the subject-character extraction process, when a start input for batch experience-value conversion has been received by the server communication control unit 48 (Y in step S200) as a result of the batch experience-value conversion button 302 being tapped at the terminal device 14, the server game processing unit 42 extracts subject characters from among the characters possessed by the player, the subject characters being characters whose duplicate numbers are greater than or equal to one and whose current maximum levels have reached the upper-limit value of one hundred (step S202).

Then, in the case where subject characters exist (Y in step S204), the server communication control unit 48 notifies the terminal device 14 of the identification information of the subject characters (step S206). Meanwhile, in the case where there is no subject character (N in step S204), the server communication control unit 48 notifies the terminal device 14 of absence information indicating the absence of subject characters (step S208).

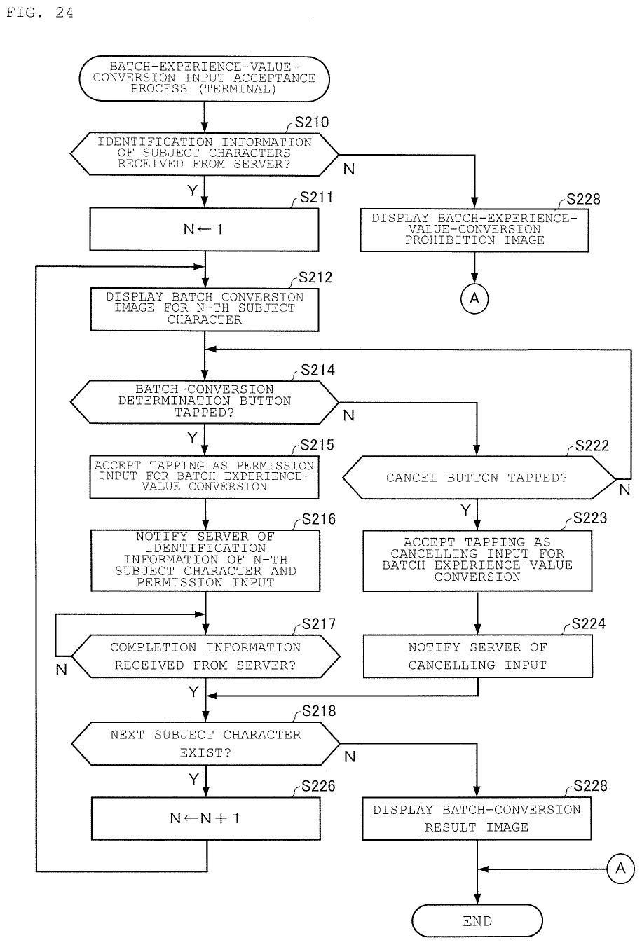

FIG. 24 is a flowchart showing the flow of a batch-experience-value-conversion input acceptance process that is performed at the terminal device 14. In the batch-experience-value-conversion input acceptance process, when the identification information of subject characters has been received from the server device 12 by the terminal communication control unit 112 (Y in step S210), the terminal game processing unit 102 sets the first subject character among N subject characters as a subject of processing (step S211), and the display control unit 104 causes the batch conversion image 304 for the first subject character to be displayed (step S212). Then, the input acceptance unit 103 determines whether or not the batch-conversion determination button 314 has been tapped in the state where a checkmark is displayed (step S214).

Furthermore, in the case where the batch-conversion determination button 314 has been tapped in the state where a checkmark is displayed (Y in step S214), the input acceptance unit 103 accepts the tapping as a permission input for batch experience-value conversion (step S215). Then, the terminal communication control unit 112 notifies the server device 12 of the identification information of the first subject character and the permission input for batch experience-value conversion (S216). When information indicating the completion of batch experience-value conversion has been received from the server device 12 by the terminal communication control unit 112 (Y in step S217), the terminal game processing unit 102 determines whether or not the next subject character exists (step S218).

Meanwhile, in the case where the batch-conversion determination button 314 has not been tapped in the state where a checkmark is displayed (N in step S214) and the cancel button 312 has been tapped (Y in step S222), the input acceptance unit 103 accepts the tapping as a cancelling input for batch experience-value conversion (step S223). Then, the terminal communication control unit 112 notifies the server device 12 of the cancelling input for batch experience-value conversion (step S224), and the terminal game processing unit 102 determines whether or not the next subject character exists (step S218).

Furthermore, in the case where the next subject character exists (Y in step S218), the second subject character among the N subject characters is set as a subject of processing (step S226), and the process returns to step S212. Meanwhile, in the case where the next subject character does not exist (N in step S218), the display control unit 104 causes the batch-conversion result image 316 to be displayed (step S228).

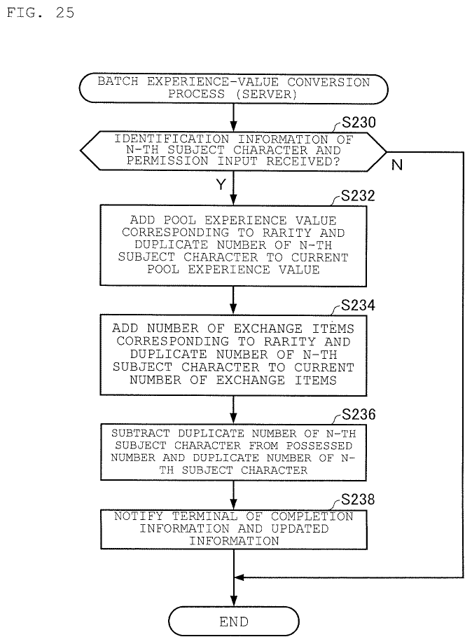

FIG. 25 is a flowchart showing the flow of a batch experience-value conversion process that is performed at the server device 12. In the batch experience-value conversion process, when the identification information of the N-th subject character and a permission input for batch experience-value conversion have been received from the terminal device 14 by the server communication control unit 48 (Y in step S230), the server parameter update unit 46 adds the pool experience value corresponding to the rarity and the duplicate number of the N-th subject character to the current pool experience value (step S232) and adds the number of exchange items corresponding to the rarity and the duplicate number of the N-th subject character to the current number of exchange items (step S234) in the server player-information storage unit 24, and subtracts the duplicate number of the N-th subject character from each of the possessed number and the duplicate number of the N-th subject character in the server character-information storage unit 22 (step S236).

Then, the server communication control unit 48 notifies the terminal device 14 of information indicating the completion of the batch experience-value conversion process, the updated pool experience value and the updated number of exchange items, and the updated possessed number and duplicate number of the N-th subject character (step S238).

### 3. Modifications

The present invention can be embodied in various modified forms, without limitation to what has been described in the context of the above embodiment, and modifications will be introduced below. Note that the various kinds of schemes described in the context of the above embodiment or the following modifications can be adopted in combination as appropriate as schemes for realizing the present invention.

First, the above embodiment has been described in the context of an example where each time a character is granted through a lottery, one is added to the possessed number of that character, and a value obtained by subtracting one from the possessed number is set as the duplicate number thereof. However, the arrangement may be such that in the case where a character granted through a lottery is not the same as any of the characters possessed by the player, one is added to the possessed number of that character, whereas in the case where a character granted through a lottery is the same as one of the characters possessed by the player, one is added to each of the possessed number and the duplicate number of that character. Alternatively, in the case where a character granted through a lottery is the same as one of the characters possessed by the player, one may be added to the duplicate number of that character, while maintaining the possessed number of that character to be one.

That is, the arrangement may be such that in the case where a character granted through a lottery is not the same as any of the characters possessed by the player, one is added to the possessed number of that character, and such that in the case where a character granted through a lottery is the same as one of the characters possessed by the player, one is added to the duplicate number of that character.

Furthermore, the above embodiment has been described in the context of an example where in the case where an over-limiting input for consuming a duplicate number has been performed, one is subtracted from each of the possessed number and the duplicate number of the selected character. Alternatively, the arrangement may be such that in the case where an over-limiting input for consuming a duplicate number has been performed, one is subtracted from the possessed number of the selected character, and a value obtained by further subtracting one from the possessed number after the subtraction is set as the duplicate number thereof.

Furthermore, the above embodiment has been described in the context of an example where in the case where a conversion input for converting a specified duplicate number is converted into a pool experience value has been performed, the specified duplicate number is subtracted from each of the possessed number and the duplicate number of the selected character. Alternatively, the arrangement may be such that in the case where a conversion input for converting a specified duplicate number into a pool experience value has been performed, the specified duplicate number is subtracted from the possessed number of the selected character, and a value obtained by further subtracting one from the possessed number after the subtraction is set as the duplicate number thereof.

Furthermore, the arrangement may be such that when a value has been added to the possessed number, a value obtained by subtracting one from the possessed number after the addition is obtained as the duplicate number, and such that when a value has been subtracted from the possessed number, a value obtained by subtracting one from the possessed number after the subtraction is obtained as the duplicate number.

Furthermore, the above embodiment has been described in the context of an example where an over-limiting input for consuming the duplicate number of a selected character is accepted in the case where the duplicate number of the selected character is greater than or equal to one, a conversion input for converting a specified duplicate number into a pool experience value is accepted in the case where the duplicate number of a selected character is greater than or equal to one, and a conversion input for converting a selected character into a pool experience value is accepted in the case where the duplicate number of the selected character is less than one. Alternatively, the arrangement may be such that an over-limiting input for consuming the duplicate number of a selected character is accepted in the case where the possessed number of the selected character is greater than or equal to two, a conversion input for converting a specified duplicate number into a pool experience value is accepted in the case where the possessed number of a selected character is greater than or equal to two, and a conversion input for converting a selected character into a pool experience value is accepted in the case where the possessed number of the selected character is less than two.

Furthermore, the above embodiment has been described in the context of an example where in the case where a conversion input for converting a selected character into a pool experience value has been performed, one is subtracted from the possessed number of the selected character, and the various kinds of parameters of the character converted into the pool experience value are reset to the initial values. Alternatively, the arrangement may be such that in the case where a conversion input for converting a selected character into a pool experience value has been performed, the various kinds of parameters of the characters converted into the pool experience value are reset to the initial values, without subtracting one from the possessed number of the selected character.

Furthermore, the above embodiment has been described in the context of an example where the possessed number and the duplicate number of each character are updated in the server character-information storage unit 22 of the server device 12, and the possessed number and the duplicate number of each character in the server character-information storage unit 22 are synchronized in the terminal character-information storage unit 57 of the terminal device 14. Alternatively, the arrangement may be such that the possessed number of each character is updated in the server character-information storage unit 22 of the server device 12 but the duplicate number thereof is not and such that in the terminal character-information storage unit 57 of the terminal device 14, the possessed number of each character in the server character-information storage unit 22 is synchronized, and a value obtained by subtracting one from the synchronized possessed number is obtained as the duplicate number.

Furthermore, the above embodiment has been described in the context of an example where the first parameter is the maximum level, the second parameter is the pool experience value, and the third parameter is the number of exchange items, in which each of the first parameter to the third parameter is a parameter with which it becomes more advantageous for the player as the value thereof increases. Alternatively, the arrangement may be such that at least one of the first parameter to the third parameter is a parameter with which it becomes more advantageous for the player as the value thereof decreases.

Furthermore, the above embodiment has been described in the context of an example where the number of game media is the duplicate number. Alternatively, the number of game media may be the possessed number. Furthermore, the above embodiment has been described in the context of an example where the duplicate number is displayed in the display area 200 on a per-character basis on the basis of the per-character duplicate number in the terminal character-information storage unit 57. Alternatively, the possessed number may be displayed in the display area 200 on a per-character basis on the basis of the per-character possessed number in the terminal character-information storage unit 57.

Furthermore, the arrangement may be such that there are cases where a particular item associated one to one with each character as an exclusive item for that character is determined through a lottery as a game medium to be granted to a player ID and such that the number of game media is a parameter that is increased in the case where a game medium determined through a lottery is the particular item.

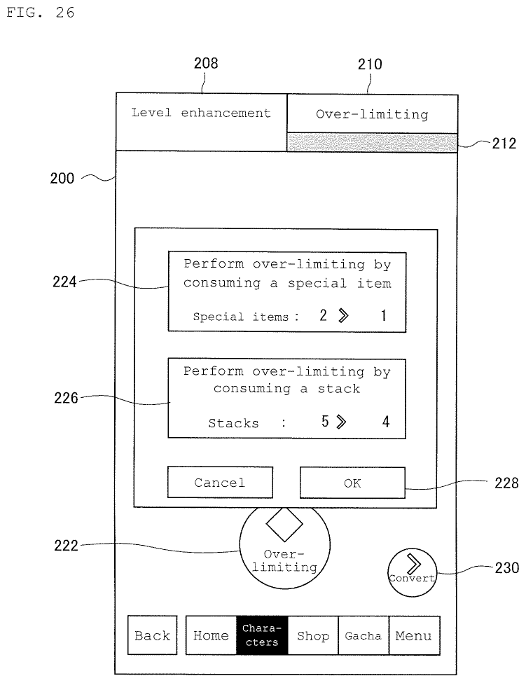

Furthermore, the above embodiment has been described in the context of an example where when the over-limiting button 222 has been tapped in the over-limiting image 215, the tapping is accepted as an over-limiting input for consuming the duplicate number of the selected character in the case where the duplicate number of the selected character is greater than or equal to one, and the tapping is accepted as an over-limiting input for consuming a special item in the case where the duplicate number of the selected character is not greater than or equal to one and the number of special items possessed is greater than or equal to one. Alternatively, the arrangement may be such that when the over-limiting button 222 has been tapped, a special-item selection button 224 for choosing to perform over-limiting by consuming a special item is displayed in the case where the number of special items possessed by the player is greater than or equal to one, as shown in FIG. 26, and a stack selection button 226 (a first indication) for choosing to perform over-limiting by consuming the duplicate number (the number of stacks) is displayed in the case where the duplicate number of the selected character is greater than or equal to one, as shown in FIG. 26. Note that in the example in FIG. 26, since the number of special items possessed by the player is greater than or equal to one and the duplicate number of the selected character is greater than or equal to one, the special-item selection button 224 and the stack selection button 226 are displayed.

Furthermore, in this example, when a selection determination button 228 is tapped after the special-item selection button 224 is tapped, one is subtracted from the number of special items possessed by the player, five is added to the current maximum level of the selected character, and one is added to the number of times of over-limiting of the selected character. Meanwhile, when the selection determination button 228 has been tapped after the stack selection button is tapped (in the case where a first player input has been performed), one is subtracted from each of the possessed number and the duplicate number of the selected character, five is added to the current maximum level of the selected character, and one is added to the number of times of over-limiting of the selected character.

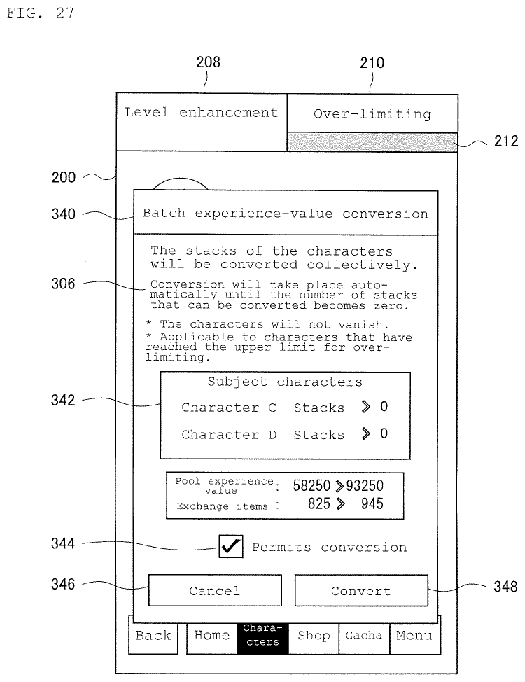

Furthermore, the above embodiment has been described in the context of an example where the batch conversion image 304 shown in FIG. 20 is displayed for each subject character. Alternatively, as shown in FIG. 27, a single batch conversion image 340 corresponding to all the subject characters may be displayed. In this case, in the batch conversion image 340, character C and character D are displayed as all the subject characters in a subject-character indication 342, and under the subject-character indication 342, the current pool experience value as well as the pool experience value after batch experience-value conversion is performed for all the subject characters are displayed. Furthermore, the current number of exchange items as well as the number of exchange items after batch experience-value conversion is performed for all the subject characters are displayed.

Furthermore, in the batch conversion image 340, a checkbox 344 for confirming that batch experience-value conversion is to be performed for all the subject characters is displayed. Furthermore, a cancel button 346 for cancelling batch experience-value conversion for all the subject characters and a batch-conversion determination button 348 for determining that batch experience-value conversion is to be performed for all the subject characters are displayed.

Furthermore, when the batch-conversion determination button 348 has been tapped at the terminal device 14 in the state where a checkmark is displayed in the checkbox 344, the tapping is accepted as a permission input for permitting batch experience-value conversion for all the subject characters, and the server device 12 is notified of the identification information of all the subject characters and the acceptance of the permission input for batch experience-value conversion.

Then, batch experience-value conversion is performed for all the subject characters at the server device 12. Specifically, the sum of the pool experience values corresponding to the rarities and the duplicate numbers of the individual subject characters is added to the current pool experience value, and the sum of the numbers of exchange items corresponding to the rarities and the duplicate numbers of the individual subject characters is added to the current number of exchange items. Furthermore, the duplicate number of each subject character is subtracted from each of the possessed number and the duplicate number of that subject character.

Meanwhile, when the cancel button 346 has been tapped, the tapping is accepted as a cancelling input for cancelling batch experience-value conversion for all the subject characters, and the server device 12 is notified of the acceptance of the input for cancelling batch experience-value conversion for all the subject characters. Then, batch experience-value conversion for all the subject characters is not performed at the server device 12.

Furthermore, the above embodiment has been described in the context of an example where all the characters whose duplicate numbers are greater than or equal to one and whose maximum levels have reached the upper-limit value of one hundred are considered as subject characters. Alternatively, all the characters whose duplicate numbers are greater than or equal to one and whose maximum levels have reached a value that is not the upper-limit value but that is greater than any reference maximum level, for example, ninety, may be considered as subject characters. Alternatively, all the characters whose duplicate numbers are greater than or equal to one and whose levels have reached one hundred, which is the upper-limit value of the maximum level, or a value that is not the upper-limit value but that is greater than any reference maximum level, for example, ninety, may be considered as subject characters.

Furthermore, the above embodiment has been described in the context of an example where the duplicate number of a character is consumed to raise the maximum level of that character or to increase the pool experience value. Alternatively, the arrangement may be such that the duplicate number of an item such as character equipment is consumed to raise an item parameter of that item, such as the attacking ability, or to raise enhancement parameters necessary to enhance various kinds of items.

For example, the arrangement may be such that the duplicate number and an enhancement parameter of an item selected by the player are consumed to raise an item parameter of the selected item within a prescribed value as an upper limit, such that the duplicate number of an item selected by the player is consumed to raise an enhancement parameter, while particular items whose item parameters have reached a prescribed value are automatically extracted on the basis of a player input, and the extracted particular items are consumed to raise the enhancement parameter. Also in this case, the number of exchange items may also be increased in the case where the enhancement parameter is raised by consuming the duplicate number of the item.

Furthermore, the above embodiment has been described in the context of an example where the number of exchange items is increased when the pool experience value is increased by consuming the duplicate number of a character. The arrangement may be such that the number of exchange items is also increased in the case where the maximum level of a character is raised by consuming a character or an item.

Alternatively, the arrangement may be such that when the pool experience value is increased by consuming the duplicate number of a character, the number of exchange items is increased, and the number of exclusive items that cannot be obtained by other methods is increased, or the arrangement may be such that when the duplicate number of a character is consumed, the number of exclusive items is increased instead of the pool experience value or exchange items.

Furthermore, the above embodiment has been described in the context of an example where each time a character that is the same as one of the characters possessed by the player is granted, the possessed number and the duplicate number of that character are increased, and the duplicate number of the character is displayed in the character button 204 for the character. Alternatively, the arrangement may be such that a possessed-character list in which the identification information of the characters possessed by the player is registered is provided in the server character-information storage unit 22, in the case where a character granted to the player is a character not registered in the possessed-character list, the identification information of that character is added as an initial character in the possessed character list, in the case where a character granted to the player is a character already registered in the possessed character list, the identification information of that character is added to the possessed-character list as a duplicate character, and one character button 204 corresponding to the initial character and the same number of character buttons 204 as the number of duplicate characters are displayed as character buttons 204 for each character. That is, each time a character that is the same as one of the characters possessed by the player is granted, a character button 204 for that character may be added.

Furthermore, in this case, the arrangement may be such that it is possible to perform over-limiting by consuming a selected duplicate character, it is possible to consume a selected duplicate character and to convert the duplicate character into a pool experience value, and it is possible to consume a selected initial character and to convert the initial character into a pool experience value. Furthermore, in this case, the arrangement may be such that, as batch experience-value conversion, it is possible to convert all the duplicate characters for each subject character into a pool experience value, where the subject characters are, among the characters possessed by the player, all the characters whose numbers of duplicate characters are greater than or equal to one and whose maximum levels have reached the upper-limit value of one hundred.

What is claimed is:

1. A program that causes a computer to function as:
a number-of-game-media update unit that, when a game medium has been granted to a player, increases the number of game media of the granted kind among game media of the player;
a first update unit that, on the basis of a first input by a player, decreases the number of game media of a selected kind among game media of the player and changes a first parameter of the game media within a prescribed value as a limit; and
a second update unit that, on the basis of a second input by a player, decreases the number of game media of a selected kind among game media of the player and changes a second parameter of the player,
wherein the second update unit, on the basis of a third input by a player, decreases the number of specific game media with which the first parameter has reached the prescribed value among game media of the player and changes the second parameter of the player.

2. A program according to claim 1,
wherein the second update unit accepts a third input by a player for each of the plurality of specific game media, decreases the number of the specific game media for which the third input by the player has been accepted, and changes the second parameter of the player.

3. A program according to claim 1,
wherein the second update unit decreases the number of the specific game media and changes the second parameter and a third parameter of the player.

4. A program according to claim 1,
wherein the second update unit resets a duplicate number of the specific game media to an initial value thereof and changes the second parameter of the player.

5. An information processing device comprising:
a number-of-game-media update unit that, when a game medium has been granted to a player, increases the number of game media of the granted kind among game media of the player;
a first update unit that, on the basis of a first input by a player, decreases the number of game media of a selected kind among game media of the player and changes a first parameter of the game media within a prescribed value as a limit; and
a second update unit that, on the basis of a second input by a player, decreases the number of game media of a selected kind among game media of the player and changes a second parameter of the player,
wherein the second update unit, on the basis of a third input by a player, decreases the number of specific game media with which the first parameter has reached the prescribed value among game media of the player and changes the second parameter of the player.

6. An information processing method that is executed by one or more computers, wherein:
when a game medium has been granted to a player, the number of game media of the granted kind among game media of the player is increased;
on the basis of a first input by a player, the number of game media of a selected kind among game media of the player is decreased, and a first parameter of the game media is changed within a prescribed value as a limit;
on the basis of a second input by a player, the number of game media of a selected kind among game media of the player is decreased, and a second parameter of the player is changed; and
on the basis of a third input by a player, the number of specific game media with which the first parameter has reached the prescribed value among game media of the player is decreased, and the second parameter of the player is changed.
